(19) United States
(12) Patent Application Publication
(10) Pub. No.: US 2011/0045222 A1
(43) Pub. Date: Feb. 24, 2011

(54) OXYGEN-SCAVENGING POLYMER BLENDS SUITABLE FOR USE IN PACKAGING

(75) Inventor: Richard Dalton Peters, Kingsport, TN (US)

Correspondence Address: DENNIS V. CARMEN, EASTMAN CHEMICAL COMPANY, 100 NORTH EASTMAN ROAD, KINGSPORT, TN, 37660-5075, US

(73) Assignee: Eastman Chemical Company, Kingsport, TN (US)

(21) Appl. No.: 12/543,739

(22) Filed: Aug. 19, 2009

(51) Int. Cl. B32B 27/18; C08K 3/10; C08K 5/09

(52) U.S. Cl. 428/35.8; 524/435; 524/176

(57) ABSTRACT

Polymer blends are disclosed that comprise one or more unsaturated olefinic homopolymers or copolymers having at least one functionality capable of entering into condensation reactions; one or more polyamide homopolymers or copolymers; one or more polyethylene terephthalate homopolymers or copolymers obtained using a catalyst system comprising antimony atoms; and one or more transition metal atoms. The inventive blends are useful for packaging, and exhibit improved oxygen-scavenging activity and lower haze compared with blends made using polyethylene terephthalate polymers prepared with antimony catalyst and either the olefinic or the polyamide homopolymers or copolymers, individually.

### FIELD OF THE INVENTION

The invention relates generally to polymer blends, and in particular, to polymer blends having oxygen-scavenging properties making them suitable for use in the packaging of oxygen-sensitive products.

### BACKGROUND OF THE INVENTION

Certain foods, beverages, and other packaged goods—such as beer and fruit juices, certain cosmetics and medicines, and the like—are sensitive to oxygen exposure, and require packages having high oxygen barrier to preserve the freshness of the contents and avoid changes in flavor, texture, or color. For many applications, the oxygen barrier properties of polyethylene terephthalate (PET) homopolymers and copolymers are satisfactory. However, for very oxygen-sensitive products, the oxygen barrier properties of such polymers do not provide adequate protection for the product.

A variety of approaches have been used to enhance the passive barrier properties of PET, including blends with high barrier polymers or additives that decrease the permeability of the resin, incorporation of impermeable fillers, the use of coated or multilayer structures, and copolymerization with comonomers that produce a lower permeability polymer than unmodified PET.

To further reduce the entry of oxygen into the contents of the package, oxygen-scavenging technologies have been developed for PET packages. These may include oxidizable moieties, such as polyamides, polydienes, or polyethers, blended or reacted into PET. Typically, small amounts of transition metal salts, such as cobalt salts of organic acids, are also incorporated to catalyze and actively promote the oxidation of the oxidizable moiety. The use of such oxidizable moieties, which chemically remove oxygen migrating through the walls of the package, can be a very effective method to reduce the oxygen transmission rates of plastics used in packaging.

U.S. Pat. No. 5,310,497 discloses a composition for scavenging oxygen that is said to have high oxygen scavenging rates at low temperatures. The composition comprises an ethylenically unsaturated hydrocarbon and a transition metal catalyst and can be incorporated into various types of layers. It is preferred that the composition be incorporated into layers of multilayered articles used for packaging oxygen-sensitive products such as food products.

U.S. Pat. No. 5,211,875 discloses a method of initiating oxygen scavenging by compositions that contain oxidizable organic compounds and transition metal catalysts. The method comprises initiating scavenging by exposing the composition to radiation. The method can be used for initiating scavenging in packaging layers or articles for oxygen sensitive products such as foods and beverages.

U.S. Pat. Nos. 5,021,515 and 5,955,527 disclose a wall for a package which comprises a polymer, and which is capable of scavenging oxygen through the metal-catalyzed oxidation of an oxidizable organic component. The oxidizable organic component may itself be a polymer, and preferred compositions are said to include a blend of 96% polyethylene terephthalate and 4% poly(m-xylyleneadipamide) containing 200 ppm cobalt as catalyst.

U.S. Pat. No. 6,083,585 discloses compositions for scavenging oxygen that comprise condensation copolymers comprising predominantly polyester segments and an oxygen-scavenging amount of polyolefin oligomer segments. The polyester segments comprise segments derived from typical bottling and packaging polyesters such as PET and PEN. The copolymers are preferably formed by transesterification during reactive extrusion and typically comprise about 0.5 to about 12 wt % of polyolefin oligomer segments. Use of these oxygen-scavenging compositions in bottles is said to provide a clear and rigid bottle similar in appearance to unmodified polyester bottles.

U.S. Pat. No. 6,544,611 discloses an oxygen-scavenging PET-based copolymer comprising from about 10 to about 120 ppm cobalt based on the PET polymer, and from about 15 to about 150 ppm zinc based on the PET polymer.

U.S. Pat. No. 6,863,988 discloses monolayer packages comprised of an oxygen scavenging composition suitable for direct contact with package contents and recycle with other polyester bottles. The oxygen scavenging composition is comprised of a modified copolymer which is comprised of predominantly polyester segments and an oxygen scavenging amount of oxygen scavenging segments. The polyester segments comprise segments derived from typical bottling and packaging polyesters such as PET and PEN. Use of these oxygen scavenging copolymers in bottles provides a clear and rigid monolayer bottle similar in appearance to unmodified polyester bottles. In a series of preferred embodiments, bottles fabricated with the oxygen scavenging copolymers of this invention are over 99 wt % PET and contain less than 50 ppb of extractable components.

U.S. Pat. No. 7,186,464 discloses an oxygen barrier composition comprising an oxygen barrier polymer and an oxygen scavenging polymer. The composition can be in the form of a physical blend or a cross-linked blend, and can further comprise a compatibilizer, a transesterification catalyst, or both. Preferably, the oxygen barrier polymer is poly(ethylene/vinyl alcohol) (EVOH), polyethylene terephthalate (PET), or polyamide other than MXD6. Preferably, the oxygen scavenging polymer comprises an ethylenic backbone and a pendant cyclic olefinic group, or the oxygen scavenging polymer is a polyamide derived at least in part from a xylene diamine-based monomer. The oxygen barrier composition can be formed into an oxygen barrier layer of a packaging article. Such layers and articles, and methods for making same, are also disclosed.

U.S. application Ser. No.11/364,916 filed Mar. 1, 2006 discloses a composition comprising (i) an aromatic polyester resin, and (ii) a polydiene, where greater than 20 mole percent of the mer units of said polydiene have a 1,2 microstructure or the hydrogenated residue thereof.

U.S. Pat. No. 6,506,463 discloses compositions for scavenging. These compositions comprise copolyamides comprising over 50 weight percent polyamide segments and an active oxygen scavenging amount of polyolefin oligomer segments. The polyamide segments comprise segments derived from typical bottling and packaging polyamides such as polyhexamethyleneadipamide and polyphthalamides. The copolymers are preferably formed by transesterification during reactive extrusion and typically comprise about 0.5 to about 12 wt. % of polyolefin oligomer segments. The copolyamides provide enhanced active and passive oxygen barrier properties over similar polyester constructions and similar polyamide constructions, when used in a laminar construction. In a series of preferred embodiments, multi-layered bottles fabricated with the oxygen scavenging copolyamides of this invention are about 99.8 wt. % polyamide and suitable for recycle with other polyamide bottles.

While compositions such as those described scavenge oxygen, and find use according to the present invention, we have found that performance may vary significantly depending upon the nature of the catalyst system used to prepare the PET polymer component.

While currently available oxygen-scavenging polymers have utility, they suffer from a variety of drawbacks when blended with some PET resins. These drawbacks include lengthy induction periods before sufficient oxygen-scavenging activity is achieved (i.e., until the oxygen transmission rate is less than 5 μL/day) and/or life spans which are too short (i.e., limited oxygen-scavenging capacities allowing the oxygen transmission rate to rise above 5 uL/day). In some instances, these deficiencies can be partially addressed by increasing the level of oxygen-scavenging polymer in the package structure. However, this typically increases the cost of the final package and produces undesirable effects on the appearance of the package, such as adding haze or color. In addition, increasing the concentration of the oxygen-scavenging polymer can complicate manufacture and recycling of the package. Therefore, a need exists for a method of improving the efficacy of oxygen-scavenging technologies to either shorten induction times or lengthen life spans (i.e., increase oxygen-scavenging capacity) without significantly increasing the concentration of the oxygen-scavenging polymer and the cost.

We have unexpectedly discovered that PET polymers made using catalyst systems containing antimony, when blended with both an olefinic oxygen-scavenging polymer and an amide oxygen-scavenging polymer of the invention and a transition metal, result in polymer blends having better oxygen-scavenging properties than polymer blends made using the oxygen-scavenging polymers individually, while maintaining the properties that make the blends suitable for use in the packaging of oxygen-sensitive products, including transparency, miscibility, rigidity, good barrier properties, recyclability, and reasonable cost.

### SUMMARY OF THE INVENTION

In one aspect, the invention relates to polymer blends having oxygen-scavenging activity that include one or more ethylenically unsaturated homopolymers or copolymers having at least one functionality capable of entering into condensation reactions; one or more polyamide homopolymers or copolymers, and especially those having for example, at least 50 mole percent monomers containing a benzylic hydrogen, based on the total amount of amine residues in the one or more polyamide homopolymer or copolymers comprising 100 mole percent; one or more polyethylene terephthalate homopolymers or copolymers obtained using a catalyst system comprising antimony atoms in an amount from, for example, at least about 100 ppm, based on the weight of the one or more polyethylene terephthalate homopolymers or copolymers; and one or more transition metal atoms in an amount from about 10 ppm to about 1,000 ppm metal, based on the total weight of the polymer blend.

In another aspect, the invention relates to polymer blends having one or more ethylenically unsaturated homopolymers or copolymers present in an amount, for example, from about 0.025 wt % to about 0.5 wt %, from about 0.025 wt % to about 0.2 wt %, or from 0.025 wt % to 0.1 wt %, based on the total weight of the polymer blend.

In another aspect, the invention relates to polymer blends having one or more ethylenically unsaturated homopolymers or copolymers provided with an average of at least two functionalities capable of entering into condensation reactions.

In still another aspect, the invention relates to polymer blends having one or more ethylenically unsaturated homopolymers or copolymers wherein the functionality capable of entering into condensation reactions comprises hydroxyl functionality.

In yet another aspect, the invention relates to polymer blends wherein the weight average molecular weight <Mw> of the one or more ethylenically unsaturated homopolymers or copolymers is, for example, from about 100 g/mole to about 10,000 g/mole or from 1,000 g/mole to 3,000 g/mole.

In another aspect, the invention relates to polymer blends wherein the one or more ethylenically unsaturated homopolymers or copolymers comprises a polybutadiene homopolymer or copolymer.

In another aspect, the invention relates to polymer blends having one or more ethylenically unsaturated homopolymers or copolymers provided as a copolycondensate comprising the reaction product of one or more polyethylene terephthalate homopolymers or copolymers and the one or more polybutadiene homopolymers or copolymers.

In another aspect, the invention relates to polymer blends comprising one or more polyamide homopolymers or copolymers present in an amount, for example, from about 0.05 weight percent to about 10 weight percent, or from 0.1 to 5 weight percent, or from 1 to 3 weight percent, in each case based on the total weight of the polymer blend.

In yet another aspect, the one or more polyamide homopolymers or copolymers may comprise, for example, at least 80 percent amide linkages, or at least 90 percent amide linkages, or at least 95 percent amide linkages, in each case based on the total number of condensation linkages of the one or more polyamide homopolymers or copolymers comprising 100 percent, and may further comprise, for example, at least 60 mole percent amine residues having a benzylic hydrogen group, based on the total amount of amine residues comprising 100 mole percent.

In another aspect, the one or more polyamide homopolymers or copolymers may comprise, for example, repeating units of m-xylylene residues, in an amount, for example, of at least 50 mole percent, or at least 75 mole percent, or at least 90 mole percent, or at least 95 mole percent, in each case based on the total moles of amine residues in the one or more polyamide homopolymers or copolymers comprising 100 mole percent.

In still another aspect, the one or more polyamide homopolymers or copolymers may comprise, for example, repeating units of m-xylylene adipamide, in an amount, for example, of at least 50 mole percent, or at least 85 mole percent, or at least 96 mole percent, or at least 100 mole percent, in each case based on the total moles of acid/amine units in the one or more polyamide homopolymers or copolymers comprising 100 mole percent.

In another aspect, the one or more polyamide homopolymers or copolymers may comprise m-xylylene adipamide homopolymer.

In another aspect, the one or more polyamide homopolymers or copolymers may be provided as a polyamide concentrate, in which the polyamide is present in an amount, for example, from about 1 weight percent to about 40 weight percent, based on the total weight of the concentrate.

In another aspect, the one or more polyamide homopolymers or copolymers may have a number average molecular weight <Mn>, for example, from about 200 g/mole to about 25,000 g/mole, or from 2,500 g/mole to 12,000 g/mole, or from 2,500 g/mole to 7,000 g/mole.

In one aspect, the invention relates to one or more polyethylene terephthalate homopolymers or copolymers that include a carboxylic acid component comprising, for example, at least about 80 mole % or at least 90 mole % of the residues of terephthalic acid and a hydroxyl component comprising, for example, at least about 80 mole % or at least 90 mole % of the residues of ethylene glycol or 1,3-propanediol, based on 100 mole percent of carboxylic acid component residues and 100 mole percent of hydroxyl component residues in the one or more polyethylene terephthalate homopolymers or copolymers.

In one aspect, the invention relates to one or more polyethylene terephthalate homopolymers or copolymers having an It.V. of, for example, at least about 0.76 dL/g, or at least 0.80 dL/g, or at least 0.84 dL/g.

In one aspect, the invention relates to one or more polyethylene terephthalate homopolymers or copolymers further comprising residues of a catalyst deactivator, including those containing phosphorus atoms, for example phosphoric acid, phosphorous acid, polyphosphoric acid, pyrophosphoric acid, carboxyphosphonic acids, or phosphonic acid derivatives, or each of their salts, esters, or derivatives.

In one aspect, the invention relates to one or more polyethylene terephthalate homopolymers or copolymers further comprising residues of a catalyst deactivator containing phosphorus atoms present in an amount such that a molar ratio of phosphorus atoms to the total moles of antimony atoms is, for example, about 1:5 to about 1:15.

In another aspect, the one or more transition metals may be present, for example, in an amount from about 10 ppm to about 200 ppm metal or from 20 ppm to 150 ppm, or from 40 ppm to 120 ppm, based on the total weight of the polymer blend. The one or more transition metals may comprise one or more transition metal salts, for example, and/or may be provided in one or more of the following oxidation states: manganese II or III, iron II or III, cobalt II or III, nickel II or III, copper I or II, rhodium II, III or IV, or ruthenium I, II or IV.

In another aspect, the one or more transition metals may be provided as a salt of one or more of a chloride, an acetate, an acetylacetonate, an octoate, a stearate, a palmitate, a 2-ethylhexanoate, a neodecanoate, or a naphthenate.

In another aspect, the one or more transition metals may comprise cobalt, that may be provided as cobalt neodecanoate, in an amount, for example, to provide cobalt atoms from 20 ppm to 120 ppm, based on the weight of the cobalt with respect to the weight of the polymer blend.

In one aspect, the invention relates to polymer blends in the form of a bottle preform.

Further aspects of the invention are as set out below.

### BRIEF DESCRIPTION OF THE DRAWINGS

FIG. 1A-1C is a plot of the oxygen transmission rate (OTR) as a function of time for three bottles made from Comparative Polymer Blend 1. A non-linear curve is superimposed over the OTR data in each plot using the parameters reported in Table 17 with Eqn. 1.

FIG. 2A-2C is a plot of the oxygen transmission rate (OTR) as a function of time for three bottles made from Comparative Polymer Blend 2. A non-linear curve is superimposed over the OTR data in each plot using the parameters reported in Table 17 with Eqn. 1.

FIG. 3A-3C is a plot of the oxygen transmission rate (OTR) as a function of time for three bottles made from Comparative Polymer Blend 3. A non-linear curve is superimposed over the OTR data in each plot using the parameters reported in Table 17 with Eqn. 1.

FIG. 4A-4C is a plot of the oxygen transmission rate (OTR) as a function of time for three bottles made from Comparative Polymer Blend 4. A non-linear curve is superimposed over the OTR data in each plot using the parameters reported in Table 17 with Eqn. 1.

FIG. 5A-5C is a plot of the oxygen transmission rate (OTR) as a function of time for three bottles made from Comparative Polymer Blend 5. A non-linear curve is superimposed over the OTR data in each plot using the parameters reported in Table 17 with Eqn. 1.

FIG. 6A-6C is a plot of the oxygen transmission rate (OTR) as a function of time for three bottles made from Comparative Polymer Blend 6. A non-linear curve is superimposed over the OTR data in each plot using the parameters reported in Table 17 with Eqn. 1.

FIG. 7A-7C is a plot of the oxygen transmission rate (OTR) as a function of time for three bottles made from Comparative Polymer Blend 7. A non-linear curve is superimposed over the OTR data in each plot using the parameters reported in Table 17 with Eqn. 1.

FIG. 8A-8C is a plot of the oxygen transmission rate (OTR) as a function of time for three bottles made from Comparative Polymer Blend 8. A non-linear curve is superimposed over the OTR data in each plot using the parameters reported in Table 17 with Eqn. 1.

FIG. 9A-9C is a plot of the oxygen transmission rate (OTR) as a function of time for three bottles made from Polymer Blend 9. A non-linear curve is superimposed over the OTR data in each plot using the parameters reported in Table 17 with Eqn. 2.

FIG. 10A-10C is a plot of the oxygen transmission rate (OTR) as a function of time for three bottles made from Polymer Blend 10. A non-linear curve is superimposed over the OTR data in each plot using the parameters reported in Table 17 with Eqn. 2.

FIG. 11A-11C is a plot of the oxygen transmission rate (OTR) as a function of time for three bottles made from Polymer Blend 11. A non-linear curve is superimposed over the OTR data in each plot using the parameters reported in Table 17 with Eqn. 2.

FIG. 12A-12C is a plot of the oxygen transmission rate (OTR) as a function of time for three bottles made from Polymer Blend 12. A non-linear curve is superimposed over the OTR data in each plot using the parameters reported in Table 17 with Eqn. 2.

### DETAILED DESCRIPTION OF THE INVENTION

The present invention may be understood more readily by reference to the following detailed description of the invention.

As used in the specification and the appended claims, the singular forms “a,” “an” and “the” include plural referents unless the context clearly dictates otherwise. For example, reference to processing or making a “polymer,” “preform,” “article,” “container,” or “bottle” is intended to include the processing or making of a plurality of polymers, preforms, articles, containers, or bottles.

Specifically, when a “polymer” is referred to in the specification and the claims, the term should be construed to include not just the reaction product of a single polymerization, but also to blends or physical mixtures of more than one polymer, since the thermoplastic polymers described herein may be satisfactorily blended with one another so that it may be difficult to afterward identify the source. Thus, the phrase a “PET homopolymer or copolymer” (sometimes hereinafter described simply as a “PET polymer”) should be construed, for example, to include both the product of a single polymerization as well as mixtures of more than one PET homopolymer or copolymer. Likewise, the phrase “polyolefin polymer” or “polybutadiene homopolymer or copolymer” should be construed, for example, to include both the reaction product of a single polymerization as well as mixtures of more than one polybutadiene homopolymer or copolymer. Similarly, the phrase “polyamide homopolymer or copolymer” should be construed, for example, to include both the reaction product of a single polymerization as well as mixtures of more than one polyamide homopolymer or copolymer.

References to a composition or a polymer blend containing “an” ingredient or “a” polymer is intended to include other ingredients or other polymers, respectively, in addition to the one named. For example, when we refer to “a” transition metal, the phrase is intended to include the use or presence of more than one transition metal. Similarly, when we refer to a PET homopolymer or copolymer, to a polybutadiene homopolymer or copolymer, or to a poly(m-xylylene adipamide)homopolymer or copolymer, the phrases are intended to include the use or presence of more than one of the respective polymers.

By “comprising” or “containing” or “having” we mean that at least the named compound, element, particle, or method step, etc., is present in the composition or article or method, but does not exclude the presence of other compounds, catalysts, materials, particles, method steps, etc., even if the other such compounds, material, particles, method steps, etc., have the same function as what is named, unless expressly excluded in the claims.

When we say oxygen-scavenging polymers are added to, blended with, or reacted with the PET polymer, the oxygen-scavenging polymers may either be added neat or as a concentrate, unless the context indicates otherwise. Furthermore, when the oxygen-scavenging polymers are functionalized and capable of reacting with the PET polymer, the oxygen-scavenging polymers may be added as a copolycondensate (e.g., as a concentrate of the functionalized oxygen-scavenging polymer comprising the condensation reaction product of the functionalized oxygen-scavenging polymer with a PET polymer; the inventive blend comprising a melt-blend of the copolycondensate with the one or more polyethylene terephthalate (PET homopolymers or copolymers, as further described herein).

It is also to be understood that the mention of one or more method steps does not preclude the presence of additional method steps before or after the combined recited steps or intervening method steps between those steps expressly identified, unless otherwise indicated. Moreover, the lettering of process steps is a convenient means for identifying discrete activities or steps, and unless otherwise specified, recited process steps can be arranged in any sequence.

Expressing a range includes all integers and fractions thereof within the range. Expressing a temperature or a temperature range in a process, or of a reaction mixture, or of a melt or applied to a melt, or of a polymer or applied to a polymer means in all cases that the limitation is satisfied if either the applied temperature, the actual temperature of the melt or polymer, or both are at the specified temperature or within the specified range.

As used throughout the specification, “ppm” is part per million by weight.

When we say “a transition metal catalyst, or an oxidation catalyst, is used in the inventive polymer blends”, the amounts given are based on the weight of the polymer blends and the measured weight of the metal in the polymer blend, not the weight of the metal compound as added to the polymer blends.

By “atoms” of a metal we mean the metal atom occupying any oxidation state, any morphological state, any structural state, and any chemical state, whether as added to or as present in the polymer or composition of matter.

By the term “residue(s)” we mean the portion of a monomer(s) which remains after the monomer(s) is condensed to form a polymer or oligomer chain, regardless of length.

When we use the term acid/amine units, we mean a unit comprising a single acid and a single amine condensed together, typically also condensed with one or more additional monomers on one or both ends of the unit. This is simply a convenient means of describing the repeating units of a polyamide comprised of amine and acid monomers.

The intrinsic viscosity (It.V.) values described throughout the description are set forth in dL/g units as calculated from the inherent viscosity measured at 25° C. in 60/40 wt/wt phenol/tetrachloroethane, as further described herein.

When we say the polymer blends of the invention have “oxygen-scavenging activity,” we mean that the blends react with oxygen within the blends or permeating through the blends, or that the blends exhibit a lower rate of transmission of oxygen through the blends than comparative polymers or blends not comprising the oxygen-scavenging polymer. Thus, blends having “oxygen-scavenging activity” absorb or react with oxygen within or permeating through the polymer blend, or exhibit reduced oxygen transmission through the blend. When we use the term “oxygen-scavenging capacity,” we refer to the total amount of oxygen the polymer blend is capable of absorbing before the polymer blend is no longer effective to absorb, or react with, oxygen.

We have discovered polymer blends that include: one or more PET homopolymers or copolymers prepared using a catalyst system comprising antimony atoms; an olefinic oxygen-scavenging polymer comprising polyolefin moieties (e.g., one or more functionalized polybutadiene homopolymers or copolymers as described herein); an amide oxygen-scavenging polymer comprising polyamide moieties (e.g., one or more polyamide homopolymers or copolymers as described herein); and a transition metal catalyst, exhibit improved oxygen-scavenging activity and reduced levels of haze compared with comparative polymer blends comprising an oxygen-scavenging polymer having only olefinic moieties or only amide moieties. For example, the comparative polymer blends of the examples which include PET homopolymers or copolymers prepared using antimony catalysts with an olefinic oxygen-scavenger, exhibited relatively poor oxygen-scavenging activity (i.e., became ineffective scavenging oxygen in less than 120 days exhibiting an oxygen transmission rate of greater than 5μL per day). Likewise, comparative polymer blends comprising only an amide oxygen-scavenging polymer exhibited an induction period and did not begin scavenging oxygen sufficient to reduce the oxygen transmission rate to less than 5 μL per day for greater than 18 days. Furthermore, attempts to increase the performance of the comparative blends by increasing the loadings of the either the olefinic- or amide-oxygen-scavenging polymer resulted in haze levels exceeding those of the inventive blends.

In one aspect, the invention relates to polymer blends that comprise one or more polyethylene terephthalate (PET) homopolymers or copolymers prepared using an antimony containing compound as a catalyst system; one or more olefinic oxygen-scavenging polymers comprising polyolefin moieties containing allylic hydrogens, tertiary hydrogens, or a mixture of both allylic and tertiary hydrogens; one or more amide oxygen-scavenging polymers comprising amide moieties containing benzyl hydrogens, and a transition metal catalyst.

Oxygen-scavenging polymers useful in this invention comprise an oxidizable organic moiety that reacts with oxygen. The oxygen scavenging polymers may be addition polymers, condensation polymers, copolymers comprising both addition polymers and condensation polymers, or a mixture thereof. Such oxygen scavenging polymers may include benzylic, allylic, or tertiary hydrogen containing oxidizable organic moieties. In one aspect, the polymer blends of the invention comprise an oxygen-scavenging polymer comprising olefinic moieties and an oxygen-scavenging polymer comprising polyamide moieties.

The polymer blends of the invention comprise one or more ethylenically unsaturated homopolymers or copolymers, such as those described in U.S. Pat. No. 5,310,497 incorporated herein by reference in its entirety and further elaborated upon below. Such one or more ethylenically unsaturated homopolymers or copolymers may be described herein simply as “polyolefins” or “olefinic oxygen-scavenging polymers.”

A variety of ethylenically unsaturated homopolymers or copolymers may be suitable for use according to the invention, so long as the ethylenically unsaturated homopolymers or copolymers are selected to provide the polymer blends of the invention with the necessary properties, for example suitable transparency and mechanical properties, as well as the appropriate processing characteristics, in addition to the requisite oxygen-scavenging activity. The ethylenically unsaturated homopolymers or copolymers need be present only in an amount necessary to provide the degree of oxygen-scavenging capacity needed for the particular application.

The term “ethylenically unsaturated homopolymers or copolymers” is used herein generally, and includes many hydrocarbons such as polyolefins, especially those containing one or more double bonds between carbon atoms in the linear chain (a.k.a., olefinics) that are capable of scavenging oxygen.

Ethylenically unsaturated hydrocarbons may be either substituted or unsubstituted.

As defined herein, an unsubstituted ethylenically unsaturated hydrocarbon is any compound which possesses at least one aliphatic carbon-carbon double bond and comprises 100% by weight carbon and hydrogen. A substituted ethylenically unsaturated hydrocarbon is defined herein as an ethylenically unsaturated hydrocarbon which possesses at least one aliphatic carbon-carbon double bond and comprises less than 100% by weight carbon and hydrogen. Suitable substituted or unsubstituted ethylenically unsaturated hydrocarbons include those having two or more ethylenically unsaturated groups per molecule. Suitable polymeric compounds include, for example, those having three or more ethylenically unsaturated groups and a molecular weight equal to or greater than about 1,000 g/mole weight average molecular weight. The amount of ethylenically unsaturated hydrocarbon may vary, so long as the desired oxygen-scavenging activity is provided and the inventive polymer blend may be formed into the desired article. Typical amounts for olefinic oxygen-scavenging polymer include, for example, from about 0.025 wt % to about 0.5 wt % ethylenically unsaturated hydrocarbon, or from 0.025 wt % to 0.2 wt %, or from 0.025 wt % to 0.1 wt % ethylenically unsaturated hydrocarbon, based on the total weight of the inventive polymer blend.

Substituted ethylenically unsaturated hydrocarbons include, for example, those with oxygen-containing moieties, such as esters, carboxylic acids, aldehydes, ethers, ketones, alcohols, peroxides, and/or hydroperoxides. Specific examples of such hydrocarbons include, but are not limited to, condensation polymers such as polyesters derived from monomers containing carbon-carbon double bonds; unsaturated fatty acids and their partially polymerized derivatives such as oleic, ricinoleic, dehydrated ricinoleic, and linoleic acids and derivatives thereof, e.g., esters. Such hydrocarbons also include polymers or copolymers derived from (meth)allyl (meth)acrylates.

Unsubstituted ethylenically unsaturated hydrocarbons include, for example, diene polymers such as polyisoprene, (e.g., trans-polyisoprene), polybutadiene (e.g., atactic-1,2-polybutadienes or 1,4-polybutadiene, which are defined as those polybutadienes possessing greater than or equal to 50% atactic-1,2 and 1,4 microstructures, respectively), and copolymers thereof, e.g., ethylene-butadiene or styrene-butadiene. Such hydrocarbons also include polymeric compounds such as polypentenamer, polyoctenamer, and other polymers prepared by olefin metathesis; diene oligomers such as squalene; and polymers or copolymers derived from dicyclopentadiene, norbornadiene, 5-ethylidene-2-norbornene, or other monomers containing more than one carbon-carbon double bond (conjugated or non-conjugated). These hydrocarbons further include carotenoids such as β-carotene.

In another aspect, the olefinic oxygen-scavenging polymers useful in the inventive polymer blends may be copolycondensates comprising predominantly segments, or moieties, of PET polymer condensed with functionalized olefinic oxygen-scavenging moieties (e.g., olefinic segments such as the unsubstituted ethylenically unsaturated hydrocarbons segments, or moieties, as described above) wherein the olefinic oxygen-scavenging moiety is present in sufficient quantity to provide the needed oxygen-scavenging capacity. Olefinic moieties for use as functionalized hydrocarbon segment in the oxygen-scavenging polymers include those disclosed in U.S. Pat. Nos. 6,083,585 and 6,544,611 and U.S. patent application Ser. No. 10/649,747 filed Aug. 8, 2003, each incorporated herein in their entirety. The olefinic moieties may vary from low molecular weight olefinic moieties (e.g., 3-hexenedioic acid;1,4-butenediol; and 1-cyclohexene-1,4-dimethanol) to high molecular weight olefinic polymers (e.g., diols of polypropylene, poly(4-methyl-1-pentene), polybutadiene, and polyethylene/polybutadiene copolymers). The oxygen-scavenging polymers may also comprise a mixture of two or more of the olefinic moieties. The polybutadiene diol moiety, for example, is suitable since it has a high oxygen scavenging propensity and is commercially available. Olefinic oligomer segments in the range of, for example, about 0.5 wt % to about 12 wt %, or 2 wt % to 8 wt %, or 2 wt % to 6 wt %, based on weight of the copolycondensate, are useful for the inventive polymer blends.

When we say that the one or more olefinic oxygen-scavenging moieties (e.g., polybutadiene homopolymers or copolymers) useful according to the invention are provided with one or more functionalities, or are polyfunctional, we mean that they are provided with one or more chemically compatible, functional groups that are capable of entering into polycondensation reactions. Examples of such functionality include hydroxyl; carboxylic acid including carboxylic acid, anhydrides, carboxylic acid chlorides, and alkyl ester derivatives of carboxylic acids; amine; and epoxy. The functionalities provided may be the same, or different, and include terminal functionalities such as hydroxyl, carboxylic acid, and amino.

When we say that the one or more oxygen-scavenging polymers (e.g., polybutadiene homopolymers or copolymers) include hydroxyl functionality, we mean that the polymers include one or more hydroxyl groups, for example in predominantly primary, terminal positions on the main hydrocarbon chain that are allylic in configuration. For example, the one or more polybutadiene homopolymers or copolymers may include at least 1.8 hydroxyl groups per molecule, or at least 2 hydroxyl groups per molecule, or up to about 3 hydroxyl groups per molecule, or even greater amounts of hydroxyl groups per polymer molecule.

Polybutadiene homopolymers or copolymers having the functionalities just described may be referred to hereinafter simply as “functionalized polybutadiene homopolymers or copolymers,” or simply as “functionalized polybutadiene,” but in each instance, the terms should be construed to include copolymers, unless otherwise indicated. We have found unhydrogenated polybutadiene homopolymers or copolymers having oxygen-scavenging activity and provided with functionality, for example at least two hydroxyl functionalities per molecule that may react with the one or more PET homopolymers or copolymers with which they are blended, to be suitable for use according to the invention. In one aspect, polybutadiene having an average of at least two functionalities capable of entering into condensations reactions or transesterification reactions during the polymerization of the PET polymer or during melt blending of the functionalized polybutadiene with the PET polymer are suitable for the inventive blends.

The functionalized polybutadiene homopolymers or copolymers useful according to the invention may be provided with one or more of a number of types of functionality. Thus, as described in U.S. Pat. No. 6,083,585, the preparation of the inventive blends, and the olefinic oxygen-scavenging polymers useful according to the invention, typically includes a step of adding functionality to at least one or more (preferably more) of the terminal sites available in the polybutadiene homopolymer or copolymer. The functionally added should be a moiety capable of entering into polycondensation reactions and forming polycondensation linkages when incorporated into a polymer. There may, of course, be more than two end sites available for functionalization when there is crosslinking or branching in the polybutadiene homopolymer or copolymer. In instances where di- or multiple-functionality is contemplated, generally it will be multiples of the same functionality (e.g., all epoxy, all hydroxyl, all carboxy, or all amino added at plural end sites of the polybutadiene homopolymer or copolymer oligomer molecule), although the invention may be practiced even when different, but chemically compatible, terminal functional groups are present on plural end sites of the polybutadiene homopolymer or copolymer. As noted, the terminal functionality should be capable of entering into polycondensation reactions. Terminal functional groups useful according to the invention include, for example, hydroxyl, carboxylic acid, carboxylic acid anhydrides, alcohol, alkoxy, phenoxy, amino, and epoxy. In another aspect, the terminal functional groups include, for example, epoxy, hydroxyl, carboxylic acid, and amino. For example, polybutadiene having hydroxyl functionality capable of entering into polycondensation reactions are suitable for the polymer blends of the invention.

In one aspect, copolycondensates suitable for the inventive polymer blends include functionalized polybutadiene homopolymer or copolymer moieties in the range from, for example, about 0.5 wt % to about 12 wt %, or 2 wt % to 8 wt %, or 2 wt % to 6 wt %, based on weight of the copolycondensate. Alternatively, the functionalized polybutadiene homopolymer or copolymer moieties in the copolycondensate may be in the range from about 0.5 wt % to about 12 wt %, or 2 wt % to 12 wt %, or 8 wt % to 12 wt %, based on weight of the copolycondensate. In another aspect, suitable ranges of functionalized polybutadiene homopolymer or copolymer moieties in the inventive blends may be, for example, about 0.025 wt % to about 0.5 wt %, or from 0.025 wt % to 0.2 wt %, or from 0.025 wt % to 0.1 wt %, based on the weight of the inventive polymer blend.

A separate step in the preparation of the inventive blends or olefinic oxygen-scavenging polymers useful according to the invention may be avoided by using polybutadiene that is already appropriately terminally-functionalized and commercially available as such. In this regard, carboxyl-terminal functional groups and hydroxyl terminal functional groups are suitable for use according to the invention since they are commercially available. Suitable products are believed to include Sartomer carboxyl-terminated polybutadiene (Sartomer product Poly bd 45CT) and hydroxyl-terminated polybutadienes (Sartomer products R2OLM; MW of 1230 g/mole and R45HTLO; MW of 2800 g/mole).

In one aspect, the olefinic oxygen-scavenging polymer may be provided to the inventive blend as a copolycondensate comprising the reaction product of a polyester polymer (e.g., a polyethylene terephthalate (PET) homopolymer or copolymers) with the functionalized polybutadiene; the inventive blend comprising a melt-blend of the copolycondensate with the one or more polyethylene terephthalate (PET) homopolymers or copolymers. In another aspect, the functionalized polybutadiene may be provided to the inventive blend neat; the inventive blend comprising a melt-blend of the neat functionalized polybutadiene and the one or more polyethylene terephthalate (PET) homopolymers or copolymers.

In yet another aspect, the olefinic oxygen-scavenging polymer may be provided to the inventive blend as a copolycondensate comprising the reaction product of a polyamide polymer (e.g., poly (m-xylyleneadipamide)) with the functionalized polybutadiene, including those further described, for example, in U.S. Pat. No. 6,506,463, incorporated herein by reference in its entirety; the inventive blend comprising a melt-blend of the copolycondensate (i.e., comprising the functionalized polybutadiene and the one or more polyamide homopolymers or copolymers) and the one or more polyethylene terephthalate (PET) homopolymers or copolymers.

In another aspect, the polymer blends of the invention may further comprise a transesterification catalyst, such as a transition metal carboxylate, to facilitate reaction of the one or more PET homopolymers with the one or more functionalized polybutadiene homopolymers or copolymers.

In still another aspect, the polymer blends of the invention comprise one or more polybutadiene homopolymers or copolymers having functionality reactive with the one or more PET homopolymers or copolymers with which they are blended, including those further described, for example, in U.S. Pat. No. 6,083,585, incorporated herein by reference in its entirety, and from which a portion of the present disclosure is derived. Suitable functionalized polybutadienes comprise hydroxyl functionality, for example in an amount of at least two hydroxyl functionalities per molecule of the polybutadiene polymer.

The functionalized polybutadiene need be present only in an amount necessary to provide the degree of oxygen scavenging capacity needed for the particular application. Typical amounts of functionalized polybutadiene include, for example, from about 0.025 wt % to about 0.5 wt % ethylenically unsaturated hydrocarbon, or from 0.025 wt % to 0.2 wt %, or from 0.025 wt % to 0.1 wt % polybutadiene moieties, based on the total weight of the inventive polymer blend.

A variety of polybutadiene homopolymers or copolymers may be suitable for use according to the invention, so long as the homopolymers or copolymers selected provide the polymer blends of the invention with the necessary properties, for example suitable transparency and mechanical properties, as well as the appropriate processing characteristics, in addition to the requisite oxygen-scavenging activity.

The basic microstructural units found in polybutadiene homopolymers and copolymers include, for example, cis-1,4; trans-1,4; and 1,2 units, as further described below.

The functionalized polybutadienes suitable for use according to the invention thus comprise residues of 1,3-butadiene, and include, for example, those known as 1,2-polybutadienes, such as atactic-1,2-polybutadiene, and those known as 1,4-polybutadienes, whatever the morphology. Suitable polymers typically have a low degree of crystallinity, for example less than 30%, as measured, for example, using wide angle x-ray scattering analysis, and a low Tg, for example less than 15° C.

The morphologies just described result from the various ways (i.e., polymerization processes) in which the functionalized polybutadiene may be made as further discussed herein.

In processes for producing the functionalized polybutadienes useful according to the invention, 1,3-butadiene monomers undergo polymerization to produce polybutadiene. In a chain propagation step, a new monomer may add at either the 2 position or the 4 position of the preceding monomer that has become a part of the polymer chain. When the new monomer bonds to the 4 position, that is, at the terminal carbon of the previous monomer, this is described as 1,4-addition. This results in a residual unsaturation at the 2,3-position of the preceding monomer such that the backbone of the polymer contains the unsaturation, which may be in either the cis or trans configuration. Alternatively, the new monomer may bond at the second position of the previous monomer, that is, a 1,2-addition. This addition results in the unsaturation in the previous monomer remaining, but as a side group with respect to the polymer backbone.

For example, suitable functionalized polybutadienes having predominantly 1,2-polybutadiene units include those having, for example, at least about 50% 1,2 units, or at least 75% 1,2 units, or at least 90% 1,2 units, as measured, for example, using infrared spectroscopy or ¹³C NMR. When functionalized polybutadienes with greater than 20 mole % 1,2 units are used as the one or more oxygen-scavenging polymer in the inventive blends, it may be desirable to hydrogenate the double bonds in the side chains (i.e., the vinyl double bonds) as described in U.S. application Ser. No. 11/364,916 filed Mar. 1, 2006, incorporated herein by reference in its entirety, to prevent unacceptable discoloration of the inventive blend when exposed to extended melt processing temperatures (e.g., when the inventive blends are recycled) and to control the number of sites for functionalization.

Similarly, suitable functionalized polybutadienes having predominantly 1,4-polybutadiene units include those having, for example, at least about 50% 1,4 units, or at least 75 % 1,4 units, or at least 90% 1,4 units, as measured, for example, using infrared spectroscopy or ¹³C NMR. Further, the 1,4 units may be predominantly cis-1,4 units; predominantly trans-1,4 units, or approximately equivalent amounts of each.

Those skilled in the art of addition polymers understand that the ratio of cis-1,4; trans-1,4 and 1,2 units, as well as the molecular weight, are a function of the polymerization temperature, the catalyst used, and the reaction medium, as further described herein.

In addition to functionalized polybutadiene homopolymers, functionalized polybutadiene copolymers may also be used according to the invention. For example, other monomers possessing secondary and tertiary hydrogens may be incorporated in the polybutadiene, such as unsubstituted, 2-substituted or 2,3-disubstituted 1,3-dienes of from 4 to 12 carbon atoms, or from 4 to 6 carbon atoms. The substituents in the 2- and/or 3-position may be, for example, hydrogen, alkyl (generally lower alkyl, e.g., of 1 to 4 carbon atoms), aryl (substituted or unsubstituted), halogen, nitro, nitrile, etc. Typical diene comonomers include isoprene; chloroprene; 2-cyano-1,3-butadiene; 2,3-dimethyl-1,3-butadiene; 2-phenyl-1,3-butadiene; 2-methyl-3-phenyl-1,3-butadiene, etc., other dienes (e.g., isoprene). Further, the copolymers useful according to the invention may further comprise styrene, vinyl acetate, acrylonitrile, vinyl chloride, allyl acrylates, 2,3-dimethylbutadiene, ethylene, propylene, isobutylene, alkyl acrylates, and methacrylates (e.g., methyl and t-butyl), and vinyl pyridines.

The functionalized polybutadienes of the invention thus comprise residues of butadiene, and may optionally include residues or segments of one or more of the foregoing, for example isoprene or polyisoprene (e.g., trans-polyisoprene), styrene residues or styrene-butadiene oligomers, segments of one or more of polypentenamer, polyoctenamer, and other polymers prepared by olefin metathesis; diene oligomers such as squalene; and polymers or copolymers derived from dicyclopentadiene, norbornadiene, 5-ethylidene-2-norbornene, or other monomers containing more than one carbon-carbon double bond (conjugated or non-conjugated), all as further described, for example, in U.S. Pat. No. 6,083,585, incorporated herein by reference in its entirety.

In another aspect, the one or more functionalized polybutadiene homopolymers or copolymers useful according to the invention typically comprise at least about 50 wt. % butadiene residue content, or at least 75 wt. % or at least 90 wt. %, or at least 95 wt. % butadiene residue content. Alternatively, the one or more functionalized polybutadiene homopolymers or copolymers may comprise polybutadiene homopolymers, comprised of substantially 100 wt. % butadiene residue content, with little or no amounts of other monomer residues present.

The molecular weight of the one or more functionalized polybutadiene homopolymers or copolymers may vary widely, but may be an important consideration depending on the end use application, since it may affect the properties of the resulting blends. For example, the use of low molecular weight segments may result in a more uniform dispersion of the segments throughout a copolycondensate. The use of lower molecular weight segments may cause the segments to be physically smaller than the segments obtained at the same loading level with higher molecular weight segments. The use of low molecular weight polybutadiene segments may thus be preferred where clarity of such copolycondensates is important. The polybutadiene segments may otherwise scatter the transmission of light, thus reducing clarity.

The weight average molecular weight, <Mw>, of the one or more functionalized polybutadiene homopolymers or copolymers may thus range, for example, from about 100 g/mole to about 10,000 g/mole, resulting in copolycondensates or blends having the desired physical and oxygen scavenging properties. Alternatively, the molecular weights may range from 1,000 g/mole to 3,000 g/mole, resulting in polycondensates that are particularly well suited for those applications in which clarity is important. The molecular weight of the one or more functionalized polybutadiene may be determined by gel permeation chromatography (GPC) using an appropriate solvent (e.g., THF) and calibrated using narrow molecular weight polybutadiene standards available from American Polymers Standard Corporation.

Thus, low molecular weight hydroxyl-terminated polybutadiene homopolymers and copolymers may be prepared by either free radical polymerization or by anionic polymerization catalyzed by a metal compound, for example lithium. The process of choice will depend on, for example, the desired type and amount of functionality, the desired comomoner composition, and the desired microstructure of the butadiene units. For example, hydrocarbon monomers having unconjugated ethylenic unsaturation such as isobutylene, propylene, butane and cyclohexene may be difficult to incorporate via anionic polymerization. Styrene, which has an unusually active vinyl group, is one exception and may be copolymerized with the conjugated dienes. Monomers such as acrylonitrile, ethylacrylate, and methyl methacrylate may also be unsuitable with anionic polymerization process because the cyano and ester groups may react with the organic metallic end groups from which chain growth propagation occurs.

Suitable functionalized polybutadiene homopolymers and copolymers, and especially hydroxyl-terminated butadiene homopolymers and copolymers, may be prepared, for example, by the methods described in U.S. Pat. Nos. 3,055,952; 3,333,015; 3,796,762; 3,987,012; 4,039,593; 4,518,770; 4,593,128; 4,883,859; 5,043,484; and 5,159,123 and U.S. application Ser. No. 11/364,916 filed Mar. 1, 2006, incorporated herein by reference in their entirety.

For example, a reaction solution may be prepared that includes, by weight, 100 parts polymerizable monomer; from about 0.5 to about 10 parts, or from 1 to 5, or from 2 to 4 parts organic peroxide initiator; from about 10 to about 200 parts, or from 25 to 100, or from 30 to 50 parts alcohol. Alternatively, as disclosed in U.S. Pat. No. 3,796,762, an essentially water-insoluble, alicyclic alcohol or ketone solvent which produces a two phase system may be employed in place of a conventional alcohol. This reaction solution is then heated, for example at a temperature in the range from greater than about 100° C. to about 200° C., or from 105° C. to 150° C., or from 115° to 130° C., for a period that may vary significantly, for example from about 10 minutes to about 10 hours, and to a conversion of monomer to polymer of, for example, at least about 35%, or at least 50%, or at least 75%, or at least 90%, or at least 95%, or at least 99%, or more. The liquid polymer produced may have, for example, at least about 1.8, or 2.0 to about 3.0, or from 2.1 to 2.5, hydroxyl groups per molecule. The molecular weight may be, for example, from about 400 to about 25,000 g/mole, or from 900 to 10,000 g/mole.

Polybutadiene homopolymers and copolymers with hydroxyl functional groups may be prepared by anionic polymerization processes, for example, as described in Kirk-Othmer Encyclopedia of Chemical Technology, Vol. 8, 4^{th} ed., (1993) pp. 1031-1045; U.S. Pat. Nos. 3,055,952; 4,039,593; 4,721,754 and 5,405,911; and U.S. application Ser. No. 11/364,916 filed Mar. 1, 2006 incorporated herein by reference in their entirety.

In anionic polymerization processes, a metal initiator is typically used to initiate the butadiene polymerization, the reaction taking place, for example, in an organic reaction medium such as a non-polar solvent (e.g., hydrocarbons like n-pentane, n-hexane, n-heptane and cyclohexane) that exhibit limited interaction with the propagating anionic ends or a polar solvent (e.g., tetrahydrofuran) that solvates the ion pair formed between the metal catalyst and propagating anionic end, as well as various mixtures of these, optionally with a structure modifier, as disclosed in U.S. Pat. No. 5,405,911 and U.S. application Ser. No. 11/364,916 filed Mar. 1, 2006. When the monomer is added to the organic solvent, an exothermic reaction occurs and the polymer is formed. Following the completion of the exotherm, excess ethylene oxide is added to the solution, followed by addition of water, to thereby form the hydroxyl-functionalized polybutadiene.

The anionic polymerization may be carried out in the presence of structure modifiers, such as diethylether or glyme, to obtain a desired amount of 1,4-addition, as described in U.S. Pat. No. 5,405,911, already cited, and U.S. application Ser. No. 11/364,916 filed Mar. 1, 2006. For example, amounts of 1,4 units from about 45 mole % to about 99 mole %, or from 55 mole % to 90 mole %, or from 70 mole % to 90 mole %, are suitable for use according to the invention.

In the functionalized polybutadienes of the invention, there may, of course, be more than two end sites available for functionalization, for example when there is crosslinking or branching in the polyolefin oligomer.

Polybutadiene homopolymers and copolymers having hydroxyl-terminal functional groups are suitable for use according to the invention, especially dihydroxyl-terminated polybutadienes having molecular weights from about 100 g/mole to about 10,000 g/mole or from 1,000 g/mole to 3,000 g/mole. For example, Sartomer products Poly BD R20LM and Poly BD R45 HTLO are well suited for use according to the invention, as are polycondensates such as those condensation copolymers comprising functionalized polybutadiene disclosed and claimed in U.S. Pat. No. 6,083,585, incorporated herein by reference.

The polymer blends of the invention further comprises an amide oxygen-scavenging polymer. Example of amide oxygen-scavenging polymers include one or more polyamide homopolymers or copolymers as described, for example, in U.S. Pat. No. 5,021,515; U.S. patent application Ser. No. 11/294249 filed Dec. 5, 2005; and U.S. patent application Ser. No. 11/354661 filed Feb. 15, 2006, incorporated herein by reference in their entirety. Such one or more polyamide homopolymers or copolymers may be described herein simply as “polyamides.”

A variety of polyamide homopolymers or copolymers may be suitable for use as amide oxygen-scavenging polymers according to the invention, so long as the polyamide homopolymers or copolymers are selected to provide the polymer blends of the invention with the necessary properties (e.g., suitable transparency and mechanical properties) as well as the appropriate processing characteristics, in addition to the requisite oxygen-scavenging effect. The polyamides need be present only in an amount necessary to provide the degree of oxygen-scavenging capacity needed for the particular application.

The term “polyamide” is used herein generally, and includes those that are homopolymers, copolymers, and terpolymers, and may be prepared by reacting a carboxylic acid functionalized monomer (e.g., a dicarboxylic acid compound) with an amine functionalized monomer (e.g., a diamine compound), or by any other known method, such as through lactams, using amino acids, or acid chlorides reacted with diamines, to form a polymer comprising predominantly amide linkages between the monomer residues. The polyamide is typically a random polymer such that the monomer units in the polymer chain are randomly arranged rather than arranged in a block fashion. “Polyamide” as used herein also includes low molecular weight polyamides and oligomers, and may comprise, for example, a dicarboxylic acid monomer condensed or end-capped with two monofunctional amine monomers. Similarly, the term “polyamide” may also describe low molecular weight polyamides comprising a diamine monomer condensed, or end-capped, with two monofunctional carboxylic acid monomers.

As used herein, the “carboxylic acid monomer” is typically a dicarboxylic acid monomer, but may also be monomers of other degrees of functionality. For example, the carboxylic acid monomers may include, in addition to or instead of the dicarboxylic acid monomers, monofunctional carboxylic acid monomers used, for example, to end-cap the polyamide, thereby affecting properties of the polyamide, such as the molecular weight and dispersion in the polymer blend. Monomers functionalized with more than two carboxylic acid groups may also be condensed into the polyamide.

Likewise, the “amine monomer” is typically a diamine monomer, but may also be monomers of other degrees of functionality. For example, the amine component may include, in addition to or instead of diamine monomers, monofunctional amine monomers used, for example, to end-cap the polyamide, thereby affecting properties of the polyamide, such as the molecular weight and dispersion in the polymer blend. Monomers functionalized with more than two amine groups may also be condensed into the polyamide to impart cross-linking.

In one aspect, the polyamide is a reaction product containing amide moieties, in an amount of at least 50%, or at least 70%, or at least 80% of the amide linkages, represented by the general formula:

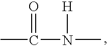

based on the total number of condensation linkages between the monomer residues comprising 100 percent. In another aspect, at least about 80%, or at least 90%, or at least 95%, or at least 98% of the linkages between different monomer residues in the polyamide polymer are amide linkages, based on the total number of linkages comprising 100 percent. The number of such amide linkages present in the polyamide may range, for example, from about 1 to about 200, or from 50 to 150.

In another aspect, the polyamide contains active methylene groups, such as may be found when a methylene group is resonance stabilized by an adjacent sp² type carbon atom. Active methylene groups include, for example, allylic group hydrogens and benzylic group hydrogens, including those present in the following structure linked to the carbon illustrated in bold:

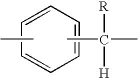

wherein R is a hydrogen or an alkyl group. The benzylic position is thus a carbon directly attached to an aryl ring. This carbon is especially reactive due to resonance stabilization of a benzylic radical or cation by the adjacent sp² carbon in the aryl ring. The aryl ring may be, for example, a phenyl ring or another polycyclic aromatic ring such as naphthyl. In one aspect, at least about 50% of the amine residues contain an active methylene group, such as an allylic group, an oxyalkylene hydrogen, or at least about 50% of the amine residues contain a benzylic hydrogen group.

In yet another aspect, the polyamide comprises residues of adipic acid and m-xylylene diamine. In one aspect, the polyamide useful according to the invention may comprise adipic acid residues in amounts, for example, of at least about 50 mole %, or at least 60 mole %, or at least 70 mole %, or at least 80 mole %, up to about 85 mole %, or up to 90 mole %, or up to 95 mole %, or up to 98 mole %, or up to 100 mole %, based on the total carboxylic acid residues in the polyamide summing to 100 mole %.

In another aspect, polyamide of the invention comprises m-xylylene diamine residues in amounts, for example, of at least about 50 mole %, or at least 60 mole %, or at least 70 mole %, or at least 80 mole %, up to about 85 mole %, or up to 90 mole %, or up to 95 mole %, or up to 98 mole %, or up to 100 mole %, in each case based on the total amine residues in the polyamide comprising 100 mole %, with the remainder of the amine residues comprising residues from one or more other amines, such as p-xylylenediamine.

In yet another aspect, the polyamide useful according to the present invention may include a copolymer comprising from about 80 to 100 mole percent adipic acid residues and from about 80 to 100 mole percent m-xylylenediamine residues, based on the total amount of carboxylic acid residues and the total amount of amine residues in the polyamide each comprising 100 mole percent. In still another aspect, the polyamide comprises from about 95 to 100 mole percent adipic acid residues and from about 90 to 100 mole percent m-xylylenediamine residues, based on the total amount of carboxylic acid residues and the total amount of amine residues in the polyamide each comprising 100 mole percent. In another aspect, the polyamide may comprise repeating units of poly(m-xylylene adipamide) in an amount of at least about 50 mole percent, or at least 60 mole percent, or at least 75 mole percent, or at least 80 mole percent, or at least 85 mole percent, or at least 90 mole percent, or at least 95 mole percent, or at least 96 mole percent, in each case based on the total moles of acid/amine units in the polyamide comprising 100 mole percent.

In addition to adipic acid residues, the carboxylic acid residues of the polyamide may comprise, for example, up to about 20 mole percent, or up to 10 mole percent, or up to 5 mole percent, or up to 2 mole percent, one or more additional carboxylic acid residues having, for example, from 2 to 20 carbon atoms, for example one or more aliphatic carboxylic acid residues having from 7-12 carbon atoms, such as residues of pimelic acid, suberic acid, azelaic acid, sebacic acid, undecandioic acid, dodecandioic acid, or 1,4-cyclohexanedicarboxylic acid. In other aspects, the carboxylic acid residues may comprise isophthalic acid, or terephthalic acid residues.

As used herein, the carboxylic acid residues may be provided as the free carboxylic acids, or the corresponding carboxylic acid derivative, for example dicarboxylic acid esters of alcohols having from 1 to 4 carbon atoms, or dicarboxylic anhydrides, or dicarboxylic acid chlorides.

The amine residues of the polyamide may include up to about 20 mole percent, or up to 10 mole percent, or up to 5 mole percent, of one or more additional amine residues having from 2 to 16 carbon atoms. Examples include p-xylylene diamine, 1,2-bisaminomethylcyclohexane, hexamethylene diamine, and mixtures thereof.

It is to be understood the amine monomer used to prepare the polyamide may not be 100% pure, and may contain reaction by-products with the identified amine monomer being the predominant monomer. The same can be said for the carboxylic acid monomer.

The polyamide of the invention may further comprise additional linkages, for example imides and amidines.

The polyamide useful in the polymer blends of the invention include, for example,
(a) a dicarboxylic acid residues of adipic acid in an amount of at least about 50 mole %, or at least 60 mole %, or at least 70 mole %, or at least 80 mole %, up to about 85 mole %, or up to 90 mole %, or up to 95 mole %, or up to 98 mole %, or up to 100 mole % with the remainder of the dicarboxylic acid residues comprising residues of, for example, isophthalic acid or terephthalic acid up to about 50 mole %, or up to 40 mole %, or up to 30 mole %, or up to 20 mole %, or up to 10 mole %, or up to 5 mole %, and mixtures thereof, in each case based on the total dicarboxylic acid residues in the polyamide summing to 100 mole, and
(b) a diamine residue comprising residues of m-xylylene diamine in amounts, for example, of at least about 50 mole %, or at least 60 mole %, or at least 70 mole %, or at least 80 mole %, up to about 85 mole %, or up to 90 mole %, or up to 95 mole %, or up to 98 mole %, or up to 100 mole %, with the remainder of the diamine residues comprising residues from one or more other diamines, such as p-xylylenediamine or hexamethylene diamine residues in an amount up to about 50 mole %, or up to 40 mole %, or up to 30 mole %, or up to 20 mole %, or up to 10 mole %, or up to 5 mole %, in each case based on the total diamine residues in the polyamide comprising 100 mole %. Examples include, but are not limited to: poly(m-xylylene adipamide) (which may be described herein as “MXD6”), poly(m-xylylene adipamide-co-isophthalamide), poly(hexamethylene isophthalamide), poly(hexamethylene isophthalamide-co-terephthalamide), poly(hexamethylene adipamide-co-isophthalamide), poly(hexamethylene adipamide-co-terephthalamide), poly(hexamethylene isophthalamide-co-terephthalamide), and the like, or mixtures thereof. In another aspect, suitable polyamides include those having residues with a benzylic hydrogen, for example polyamides such as poly(m-xylylene adipamide), poly(m-xylylene isophthalamide-co-terephthalamide), poly(m-xylylene adipamide-co-isophthalamide), and mixtures thereof. We have found poly(m-xylylene adipamide), available from Mitsubishi Gas and Chemical Company, Chiyodaku, Tokyo, Japan, to be suitable for use according to the invention.

The number average molecular weight of the polyamide is not particularly limited. The number average molecular weight, <Mn>, may be, for example, at least about 1,000 g/mole, up to, for example, about 45,000 g/mole. Alternatively, the <Mn> of the polyamide may be at least 2,500 g/mole, or at least 3,500 g/mole, or at least 5000 g/mole, up to 7,000 g/mole, or up to 12,000 g/mole, or up to about 25,000 g/mole. If desired, low molecular weight polyamide may be used in the range from about 200 g/mole, or from 300 g/mole, or from 500 g/mole, or from 1,000 g/mole up to about 12,000 g/mole, or from 2,000 g/mole to 10,000 g/mole, or from 2,500 g/mole to 7,000 g/mole. If optical clarity of the polymer blend is important, we believe that the use of low molecular weight polyamide may interfere less with light transmission. The number average molecular weight <Mn> of the polyamide polymer may be determined from the terminal carboxyl group concentration and a terminal amine group concentration using potentiometric titration as set forth in U.S. application Ser. No. 11/294,249 filed Dec. 5, 2005, incorporated herein by reference in its entirety.

In another aspect, the polyamide useful according to the invention includes those described in U.S. patent application Ser. No. 11/354,661 filed Feb. 15, 2006, incorporated herein by reference in its entirety. For example, the polyamide may comprise adipic acid condensed with two monofunctional or difunctional amines, for example having a benzylic hydrogen, such as from a benzyl amine. The monomers may be the same or different. Alternatively, the polyamide may be low molecular weight and comprise m-xylylenediamine condensed with two monofunctional or difunctional monomers such as carboxylic acids (e.g., formic, acetic, propionic, butyric, valeric acid, benzoic) or an acid chloride. The monomers may be the same or different. The molecular weight of such molecules will depend in part upon whether the monomers are monofunctional or difunctional, that is, whether the monomers include linking groups to further react with additional monomers.

In yet another aspect, the polyamide may be added, either neat or as a concentrate, to the PET polymer. When a portion of the one or more PET homopolymers or copolymers is blended with the one or more polyamide homopolymers or copolymers so as to form such a concentrate, the amount of polyamide in such concentrate may vary, for example, from about 0.5 wt. % to about 40 wt. %, or from 5 wt. % to 30 wt. %, or from 10 wt. % to 25 wt. %, in each case based on the total weight of the concentrate. The concentrate may then be further blended with additional amounts of one or more PET homopolymers or copolymers to obtain the amounts of polyamide ultimately present in the polymer blends of the invention. The total amount of the polyamide in the polymer blends of the invention may vary widely, and will depend in part on the degree of oxygen-scavenging that is desired for the particular application. Typically, the total amount of the one or more polyamide homopolymers or copolymers in the blend of the invention will be, for example, from about 0.05 to about 10 wt. %, or from 0.1 wt % to about 5 wt %, or from 1 wt % to 3 wt %, in each case based on the total weight of the inventive blend. In another embodiment, the amount of polyamide polymer ranges from about 1.0 wt. %, or from 1.20 wt. %, up to about 3.0 wt. %, or up to 2.5 wt. %, or up to 2.0 wt. %, based on the total weight of the inventive blend.

The polyamides of the invention may be prepared, for example, by melt phase polymerization of a diamine and a dicarboxylic acid in stoichiometric amounts as described, for example, in U.S. Pat. No. 5,416,189, incorporated herein by reference in its entirety. The polyamide may be prepared by first heating the acid to its melting point, or alternatively to the temperature sufficient to prevent subsequent solidification, which is typically between about 160° C. and about 230° C., or between 170° C. and 180° C., and then introducing the diamine, in its liquid state. Once the diamine is introduced, polycondensation takes place with the consequence of an increase in pressure; the maximum pressure being maintained to no greater than 10 bar. Commencing with the addition of the diamine, the reaction temperature is increased above the melting point of the polyamide (e.g., about 245° C. for MXD6) to avoid solidification of the polyamide. Once the polycondensation reaction has finished, the pressure may be reduced to atmospheric, or even to a pressure less than atmospheric pressure, leading to an increase in the mean molecular weight of the polyamide; during this step the temperature may be increased to facilitate extrusion and pelletization of the polyamide from the polycondensation reactor. Additional conventional methods that may be used to prepare the polyamides of the invention are described in Principles of Polymerization”4th ed by George Odian, 2004, pp 97-101; “Seymour/Carraher's Polymer Chemistry” 6^{th} ed rev and expanded, 2003, pp. 217-221; and “Polymer Synthesis: Theory and Practice” 3rd ed by D. Braun, 2001, pp.233-243.

The polymer blends of the invention further comprise a transition metal as an oxidation catalyst. Although we use the term “catalyst,” the transition metal may or may not be consumed in the oxidation reaction, or if consumed, may only be consumed temporarily and thereafter converted back to a catalytically active state.

The amount of transition metal used in the inventive blends is an amount effective to induce oxygen scavenging in the blend. This amount may vary depending on, for example, the transition metal used, the oxygen-scavenging polymer and loading, and the degree of oxygen scavenging desired or needed in the application. For example, one or more transition metals, such as cobalt provided as a cobalt salt, may be present in the polymer blends of the invention in amounts, for example, from about 10 ppm to about 300 ppm, or from 20 ppm to 200 ppm, or from 25 ppm to 100 ppm, in each case expressed as the weight of the metal atoms based on the total weight of the polymer blends. Alternatively, the transition metal may be present in the blends of the invention in an amount of at least about 10 ppm, or at least 15 ppm, or at least 25 ppm, or at least 50 ppm, up to 75 ppm, or up to 100 ppm, or up to 200 ppm, or up to about 400 ppm, in each case expressed as the weight of the metal atoms based on the total weight of the blend. If present in the inventive blends, the transition metal may be present in amounts, for example, from about 10 ppm to about 200 ppm or more, or from 20 ppm to 140 ppm, or from 20 ppm to 120 ppm, or from 40 ppm to 120 ppm, or from 25 ppm to 75 ppm, in each case expressed as the weight of the metal atoms based on the total weight of the blends.

Suitable transition metals include those which can readily interconvert between at least two oxidation states. The transition metal may be provided in the form of a transition metal salt, with the metal selected from the first, second, or third transition series of the Periodic Table. Suitable metals and oxidation states include manganese II or III, iron II or III, cobalt II or III, nickel II or III, copper I or II, rhodium II, III or IV, and ruthenium I, II or IV. Suitable counterions for the metal include, but are not limited to, chloride, acetate, acetylacetonate, stearate, palmitate, 2-ethylhexanoate, neodecanoate, octanoate, or naphthenate, and mixtures thereof. The metal salt may also be an ionomer, in which case a polymeric counterion is employed. An amount of catalyst which is effective in catalyzing oxygen scavenging may be used. Typical amounts in the blends of the invention are at least about 10 ppm, or at least 25 ppm, or at least 50 ppm, up to 100 ppm, or up to about 200 ppm, or from 20 ppm up to 120 ppm. For example, cobalt neodecanoate is found to effectively induce oxygen scavenging in the inventive blends in amounts from about 50 ppm up to about 200 ppm cobalt, based on the weight of cobalt to the weight of the inventive polymer blend.

Typical amounts of transition metal catalysts, if provided in the oxygen-scavenging polymer, may be even higher, for example at least about 50 ppm, or at least 250 ppm, or at least 500 ppm, up to 1,000 ppm, or up to 2,500 ppm, or up to 5,000 ppm, or up to about 10,000 ppm or more, based on the weight of the oxygen-scavenging polymer. Thus, these oxygen-scavenging polymers may also serve as a carrier to be blended with the transition metal catalyst and subsequently introduced into the blends of the invention. It may be advantageous, however, to add the transition metal shortly before or during blending the oxygen-scavenging polymer with the one or more polyester homopolymers or copolymers to impart the maximum oxygen-scavenging capacity to the inventive polymer blends.

We have found cobalt salts to be suitable for use according to the invention.

When the inventive blends are intended for packaging compositions, one or more transition metal catalysts in amounts ranging from, for example, about 10 ppm to about 1,000 ppm are suitable for most applications, or in amounts of at least 10 ppm or at least 30 ppm, or at least 50 ppm, or at least 60 ppm, or at least 75 ppm, or at least 100 ppm, or at least 200 ppm. Alternatively, the transition metal catalyst may be present in an amount up to about 300 ppm, or up to 200 ppm, or up to 100 ppm, or up to 75 ppm, or up to 50 ppm, or up to 25 ppm, or up to 10 ppm, based on the weight of the inventive blend.

The amounts given are based on the weight of the polymer blends and measured as the metal, not the compound weight as added to the inventive blends. In the case of cobalt as the transition metal, suitable amounts may be at least 20 ppm, or at least 30 ppm, or at least 50 ppm, or at least 60 ppm, or at least 100 ppm, or at least 125 ppm, or at least about 250 ppm. Alternatively, the cobalt may be present in an amount up to about 200 ppm, or up to 100 ppm, or up to 75 ppm, or up to 50 ppm, or up to 25 ppm, or up to 10 ppm, based on the weight of the inventive blend.

In those cases in which the transition metal is added during polymerization of one or more of the PET polymers, it may be necessary or helpful to add the transition metal near the end of the polymerization process, or even later during blending to prepare the inventive blends, in order to retain the desired catalytic activity of the transition metal. For example, the transition metal may be added neat or in a carrier (such as a liquid or wax) to an extruder or other device for making an article comprising the polymer blends of the invention, or it may be added in a concentrate with an additional PET polymer or other thermoplastic polymer, or in a concentrate with one of the oxygen-scavenging polymers (e.g., the olefinic oxygen-scavenging polymer or copolycondensate). The carrier may either be reactive or non-reactive with the PET polymer and either volatile or non-volatile carrier liquids may be employed.

Analogous to the blending protocols described below for introducing the oxygen-scavenging polymers into the PET polymer, it is evident that the transition metal catalyst may be added at a variety of points and via a variety of blending protocols during the preparation of the oxygen-scavenging polymer blends of the invention. An approach is to bring the inventive blends and the transition metal together late in the preparation of the blends. In some instances, such as when cobalt is provided as a transition metal, it may be useful to add the cobalt during blending of the PET polymer and the oxygen-scavenging polymers (e.g., during a secondary fabrication process such as bottle preform molding), rather than earlier, for example during the PET polymer polymerization process.

The oxygen-scavenging polymers may also comprise a mixture of two or more oxygen-scavenging polymers or oxygen-scavenging copolycondensates as described above, as well as, a mixture of two or more transition metal catalyst.

The one or more PET homopolymers or copolymers of which the inventive blends are comprised, sometimes hereinafter described simply as the “PET polymer,” are thermoplastic and include a catalyst system comprising antimony atoms, for example in an amount from about 75 ppm to about 400 ppm based on the weight of the PET polymer. Such polymer typically has an It.V. of at least about 0.72 dL/g.

In another aspect, the PET polymer comprises antimony atoms provided as a catalyst system, and optionally further comprise one or more phosphorus containing compounds, further elaborated upon below.

The polymer blends of the invention, containing one or more PET homopolymers or copolymers prepared using the catalyst systems just described and further elaborated upon below, blended with one or more olefinic oxygen-scavenging polymers (e.g., one or more polybutadiene homopolymers or copolymers) and one or more amide oxygen-scavenging polymers described elsewhere herein, often maintain significant oxygen-scavenging activity compared with PET polymer prepared using antimony and either the olefinic oxygen-scavenging polymer or the amide oxygen-scavenging polymer alone.

In another aspect, the one or more PET homopolymers or copolymers useful according to the invention comprise antimony atoms and further comprise particles of one or more of: titanium, zirconium, vanadium, niobium, hafnium, tantalum, chromium, tungsten, molybdenum, iron, nickel, or nitrides or carbides of the foregoing, for example titanium nitride, titanium carbide, or mixtures thereof, the particles improving the reheat rate of the PET polymer.

In another aspect, the one or more PET homopolymers or copolymers may be prepared by a process comprising polycondensing a PET polymer melt in the presence of antimony atoms and before, during, or after polycondensation, adding particles comprising titanium, zirconium, vanadium, niobium, hafnium, tantalum, chromium, tungsten, molybdenum, iron, or nickel atoms or combinations thereof.

The particles may comprise transition metal compounds containing the atoms of boron, carbon, and nitrogen; transition elemental metals, and transition metal alloys, wherein the transition atom comprises titanium, zirconium, vanadium, niobium, hafnium, tantalum, chromium, tungsten, molybdenum, iron, or nickel atoms or combinations thereof, for example titanium nitride, or titanium carbide, or mixtures thereof.

The antimony atoms may be present, for example, in an amount from about 75 ppm to about 400 ppm, or 100 ppm to 350 ppm, or 150 to 300 ppm, in each case based on the total weight of the PET polymer.

In one aspect, the PET polymer may have intrinsic viscosities (It.V.) in the range, for example, of about 0.52 to about 1.1, or inherent viscosities (Ih.V) in the range of about 0.50 to about 0.90. In another aspect, the PET polymer useful in the inventive blends has an intrinsic viscosity of, for example, at least about 0.70 dL/g, or at least 0.76 dL/g, or at least 0.80 dL/g, or at least 0.84 dL/g.

Thus, in one aspect, the PET polymer comprises antimony atoms, present in an amount of from about 100 ppm to about 300 ppm, based on the weight of the polymer, said polymer having an It.V. of at least about 0.72 dL/g.

In another aspect, the PET polymer comprises phosphorus atoms in an amount from about 5 ppm to about 60 ppm, 10 ppm to 40 ppm, 20 ppm to 40 ppm, or 20 ppm to 30 ppm, based on the weight of the PET polymer.

The PET polymer useful according to the invention comprises:
(i) a carboxylic acid component comprising at least about 80 mole % of the residues of terephthalic acid or diester derivates of terephthalic acid (e.g., dimethylterephthalate) and
(ii) a hydroxyl component comprising at least about 80 mole % of the residues of ethylene glycol or 1,3-propanediol, based on 100 mole percent of carboxylic acid component residues and 100 mole percent of hydroxyl component residues in the PET polymer(s).

Typically, the PET polymer is made by a process comprising esterification wherein diols comprising ethylene glycol are reacted with dicarboxylic acids comprising terephthalic acid (as the free acid or its C₁-C₄ dialkyl ester derivative) to produce an ester monomer and/or oligomers, followed by polycondensation of the ester monomer and/or oligomers to produce the PET polymer. More than one compound containing carboxylic acid group(s) or derivative(s) thereof may be reacted during the process. All the compounds that enter the process containing carboxylic acid group(s) or derivative(s) thereof that become part of the PET polymer comprise the “carboxylic acid component.” The mole % of all the compounds containing carboxylic acid group(s) or derivative(s) thereof that are in the product add up to 100 mole %. The “residues” of compound(s) containing carboxylic acid group(s) or derivative(s) thereof that are in the PET polymer refers to the portion of the compound(s) which remains in the PET polymer after the compound(s) is condensed with a compound(s) containing hydroxyl group(s) and further polycondensed to form PET polymer chains of varying length.

More than one compound containing hydroxyl group(s) or derivatives thereof can become part of the PET polymer. All the compounds that enter the process containing hydroxyl group(s) or derivatives thereof that become part of the PET polymer comprise the hydroxyl component. The mole % of all the compounds containing hydroxyl group(s) or derivatives thereof that become part of the PET polymer add up to 100 mole %. The “residues” of hydroxyl functional compound(s) or derivatives thereof that become part of the PET polymer refers to the portion of the compound(s) which remains in the PET polymer after the compound(s) is condensed with a compound(s) containing carboxylic acid group(s) or derivative(s) thereof and further polycondensed to form chains of PET polymer of varying length.

The mole % of the hydroxyl residues and carboxylic acid residues in the PET polymer may be determined, for example, by proton NMR.

In other aspects, the one or more PET homopolymers or copolymers comprise:
(a) a carboxylic acid component comprising at least about 90 mole %, or at least 92 mole %, or at least 96 mole % of the residues of terephthalic acid or diester derivates of terephthalic acid (e.g., dimethylterephthalate) and
(b) a hydroxyl component comprising at least about 90 mole %, or at least 92 mole %, or at least 96 mole % of the residues of ethylene glycol or 1,3-propanediol,

based on 100 mole percent of the carboxylic acid component residues and 100 mole percent of the hydroxyl component residues in the PET polymer.

Carboxylic acid and glycol modifiers, as described below, may be present in amount, for example, up to about 20 mole %, or up to 10 mole %, or up to 8 mole %, or up to 5 mole %, based on the 100 mole percent of their respective component, carboxylic acid or hydroxyl, in the PET polymer. Mono-, tri-, and higher-functional modifiers are typically present and/or added in amounts of only up to about 8 mole %, or up to 4 mole %, or up to 2 mole %, based on the 100 mole percent of their respective component, carboxylic acid or hydroxyl, in the PET polymer.

Derivatives of terephthalic acid suitable for inclusion include C₁-C₄ dialkylterephthalates, such as dimethylterephthalate.

In addition to a diacid component of terephthalic acid or derivatives of terephthalic acid, the carboxylic acid component(s) of the present PET polymer may include one or more additional carboxylic acid compounds as modifiers, such as isophthalic acid, diester derivatives of isophthalic acid, naphthalene-2,6-dicarboxylic acid, derivatives of naphthalene-2,6-dicarboxylic acid, or mixtures thereof, mono-carboxylic acid compounds, other dicarboxylic acid compounds, and compounds with a higher number of carboxylic acid groups. Examples include aromatic dicarboxylic acids having 8 to 14 carbon atoms, aliphatic dicarboxylic acids having 4 to 12 carbon atoms, or cycloaliphatic dicarboxylic acids having 8 to 12 carbon atoms. More specific examples of dicarboxylic acid modifiers useful as part of an acid component(s) are phthalic acid, isophthalic acid, naphthalene-2,6-dicarboxylic acid, cyclohexane-1,4-dicarboxylic acid, cyclohexanediacetic acid, diphenyl-4,4′-dicarboxylic acid, succinic acid, glutaric acid, adipic acid, azelaic acid, sebacic acid, and the like. It should be understood that use of the corresponding acid anhydrides, esters, and acid chlorides of these acids are included in the term “carboxylic acid”. It is also possible the carboxylic acid component may include tricarboxyl compound branching agents and compounds with a higher number of carboxylic acid groups to modify the PET polymers, along with monocarboxylic acid chain terminators.

In addition to a hydroxyl component comprising ethylene glycol, the hydroxyl component of the present PET polymer may include additional modifier mono-ols, diols, or compounds with a higher number of hydroxyl groups. Examples of hydroxyl modifiers include cycloaliphatic diols having 6 to 20 carbon atoms and/or aliphatic diols having 3 to 20 carbon atoms. More specific examples of such diol modifiers include diethylene glycol; triethylene glycol; 1,4-cyclohexanedimethanol; propane-1,3-diol; butane-1,4-diol; pentane-1,5-diol; hexane-1,6-diol; 3-methylpentanediol-(2,4); 2-methylpentanediol-(1,4); 2,2,4-trimethylpentane-diol-(1,3); 2,5-ethylhexanediol-(1,3); 2,2-diethyl propane-diol-(1,3); hexanediol-(1,3); 1,4-di-(hydroxyethoxy)-benzene; 2,2-bis-(4-hydroxycyclohexyl)-propane; 2,4-dihydroxy-1,1,3,3-tetramethyl-cyclobutane; 2,2-bis-(3-hydroxyethoxyphenyl)-propane; and 2,2-bis-(4-hydroxypropoxyphenyl)-propane. As hydroxyl component modifiers, the PET polymer may contain such comonomers as 1,4-cyclohexanedimethanol and diethylene glycol.

The PET polymer may be blended with polyalkylene naphthalates or other thermoplastic polymers such as polycarbonate (PC). In one aspect, however, the PET polymer is comprised predominantly of repeating polyethylene terephthalate polymers, for example in an amount of at least about 80 wt. %, or at least 90 wt. %, or at least 95 wt. %, based on the total weight of the PET polymer.

In one aspect, the polymer blend contains less than about 60 wt %, or less than 40 wt %, or less than 20 wt. %, or less than 10 wt. %, or less than 5 wt. %, or no post-consumer recycled polyester polymer (“PCR”), based on the total weight of all polyester polymers. In another embodiment, the polymer blend contains PCR in an amount of greater than zero and up to about 60 wt %, or up to 40 wt. %, or up to 20 wt %, or up to 10 wt. %, based on the total weight of all polyester polymers.

The PET polymer useful according to the invention thus includes antimony atoms, in the form of an antimony residue that remains in the PET polymer melt upon addition of the antimony compound to the melt-phase polymerization process for making the PET polymer, without regard to the oxidation state, morphological state, structural state, or chemical state of the antimony compound as added or of the residue present in the composition. The antimony residue may be identical in form to the antimony compound as added to the melt-phase polymerization process, but typically will be altered since the antimony is believed to participate in accelerating the rate of polycondensation. By the term “antimony atoms” or “antimony” we mean the presence of antimony in the PET polymer detected through any suitable analytical technique regardless of the oxidation state of the antimony. Suitable detection methods for the presence of antimony include X-ray fluorescence spectroscopy (XRF). The concentration of antimony is reported as the parts per million of metal atoms based on the weight of the PET polymer. The term “metal” does not imply a particular oxidation state.

In another aspect, antimony may additionally be used as a reheat additive, in amounts for example, from about 5 ppm to about 30 ppm, or from 10 ppm to 20 ppm.

The PET polymer may be prepared by conventional polymerization procedures sufficient to affect ester interchange or esterification, and polycondensation. PET melt phase manufacturing processes include direct condensation of a dicarboxylic acid with a diol optionally in the presence of esterification catalysts in the esterification zone, followed by polycondensation in the prepolymer and finishing zones in the presence of a polycondensation catalyst; or else ester interchange usually in the presence of a transesterification catalyst in the esterification zone, followed by prepolymerization and finishing in the presence of a polycondensation catalyst, and each may optionally be subsequently solid-stated according to known methods. After melt phase polycondensation, the PET polymer may be solid-state polymerized and typically have an initial intrinsic viscosity (It.V.) ranging from 0.55 dL/g to about 0.70 dL/g as precursor pellets and a final It.V. ranging from about 0.70 dL/g to about 1.15 dL/g after solid-state polymerization.

To further illustrate, a mixture of one or more dicarboxylic acids, including terephthalic acid or ester forming derivatives thereof, and one or more diols, including ethylene glycol, are continuously fed to an esterification reactor operated at a temperature of between about 200° C. and about 300° C., typically from 230° C. to 290° C., or from 240 to 270 ° C., and at a pressure from about 1 psig to about 70 psig. The residence time of the reactants typically ranges from about one to about five hours. Normally, the dicarboxylic acid is directly esterified with diol(s) at elevated pressure and at a temperature from about 240° C. to about 270° C. The esterification reaction is continued until a degree of esterification of at least about 60% is achieved, but more typically until a degree of esterification of at least 85% is achieved to make the desired monomer. The esterification monomer reaction is typically uncatalyzed in the direct esterification process and catalyzed in ester interchange (a.k.a. transesterification) processes. Polycondensation catalysts may optionally be added in the esterification zone along with esterification/ester interchange catalysts.

Typical esterification/ester interchange catalysts which may be used include, for example, titanium alkoxides, dibutyl tin dilaurate, used separately or in combination, optionally with zinc, manganese, or magnesium acetates or benzoates and/or other such catalyst materials as are well known to those skilled in the art. In addition, phosphorus-containing compounds (referred to herein as a “catalyst deactivator”) may also be used to stabilize or deactivate esterification/esterification interchange catalysts introduced in the esterification zone.

The resulting products formed in the esterification zone include monomer, low molecular weight oligomers, diethylene glycol (DEG), and water as the condensation by-product, along with other trace impurities formed by the reaction of the catalyst and other compounds such as colorants or the phosphorus-containing compounds. The relative amounts of monomer and oligomeric species will vary depending on whether the process is a direct esterification process, in which case the amount of oligomeric species are significant and even present as the major species, or an ester interchange process (a.k.a. “transesterification process”), in which case the relative quantity of monomer predominates over the oligomeric species. The water is removed as the esterification reaction proceeds and excess glycol removed to provide favorable equilibrium conditions. The esterification zone typically produces the monomer and oligomer mixture, if any, continuously in a series of one or more reactors. Alternatively, the monomer and oligomer mixture could be produced in one or more batch reactors.

Once the ester monomer is made to the desired degree of esterification, it is transported from the esterification reactors in the esterification zone to the polycondensation zone comprised of a prepolymer zone and a finishing zone.

Polycondensation reactions are initiated and continued in the melt phase in a prepolymerization zone and finished in the melt phase in a finishing zone, after which the melt may be solidified into precursor solids in the form of chips, pellets, or any other shape. For convenience, solids are referred to as pellets, but it is understood that a pellet can have any shape, structure, or consistency. If desired, the polycondensation reaction may be continued by solid-stating the precursor pellets in a solid-stating zone. Alternatively, the It.V. build may be accomplished entirely in the melt phase, and a subsequent solid-stating step omitted entirely.

Although reference is made to a prepolymer zone and a finishing zone, it is to be understood that each zone may comprise a series of one or more distinct reaction vessels operating at different conditions, or the zones may be combined into one reaction vessel using one or more sub-stages operating at different conditions in a single reactor. That is, the prepolymer stage can involve the use of one or more reactors operated continuously, one or more batch reactors or even one or more reaction steps or sub-stages performed in a single reactor vessel. In some reactor designs, the prepolymerization zone represents the first half of polycondensation in terms of reaction time, while the finishing zone represents the second half of polycondensation. While other reactor designs may adjust the residence time between the prepolymerization zone to the finishing zone at about a 2:1 ratio, a common distinction in designs between the prepolymerization zone and the finishing zone is that the latter zone is typically operated at a higher temperature, lower pressure, and a higher surface renewal rate than the operating conditions in the prepolymerization zone. Generally, each of the prepolymerization and the finishing zones comprise one or a series of more than one reaction vessel, and the prepolymerization and finishing reactors are sequenced in a series as part of a continuous process for the manufacture of the PET polymer.

In the prepolymerization zone, also known in the industry as the low polymerizer, the low molecular weight monomers and minor amounts of oligomers are polymerized via polycondensation to form PET polymer in the presence of a catalyst. If the catalyst was not added in the monomer esterification stage, the catalyst is added at this stage to catalyze the reaction between the monomers and low molecular weight oligomers to form prepolymer and split off the diol as a by-product. If a polycondensation catalyst was added to the esterification zone, it is typically blended with the diol and fed into the esterification reactor as the diol feed. Other compounds such as phosphorus-containing compounds, cobalt compounds, and colorants may also be added in the prepolymerization zone. These compounds may, however, be added in the finishing zone instead of or in addition to the prepolymerization zone.

In a typical ester interchange-based process, those skilled in the art recognize that other catalyst material and points of adding the catalyst material and other ingredients may vary from a typical direct esterification process.

Typical polycondensation catalysts include the compounds of antimony, titanium, germanium, zinc and tin in an amount ranging from 0.1 ppm to 1,000 ppm based on the weight of resulting polyester polymer. A common polymerization catalyst added to the prepolymerization zone is an antimony-based polymerization catalyst. Suitable antimony-based catalysts include antimony (III) and antimony (V) compounds recognized in the art, and in particular, diol-soluble antimony (III) and antimony (V) compounds with antimony (III) being most commonly used. Other suitable compounds include those antimony compounds that react with, but are not necessarily soluble in, the diols, with examples of such compounds including antimony (III) oxide. Specific examples of suitable antimony catalysts include antimony (III) oxide and antimony (III) acetate, antimony (III) glycolates, antimony (III) ethyleneglycoxide and mixtures thereof. The typical amount of antimony catalyst added is that effective to provide a level of between about 75 ppm and about 400 ppm of antimony by weight of the resulting PET polymer.

The phosphorus containing compound may be added at any point in the melt phase process. For example, the phosphorus containing compound may be added at any point in the melt phase process, including as a feed to the esterification zone, during esterification, to the oligomeric mixture, to the beginning of polycondensation, and during or after polycondensation.

In the ester interchange reaction, the phosphorus containing compound or other compounds may be an effective catalyst deactivator for deactivating ester interchange catalysts and may additionally be added at the conclusion of the ester interchange reaction and before polycondensation in molar amounts sufficient to deactivate the ester interchange catalyst without significantly impairing the catalytic activity of the antimony containing catalyst added after deactivating the ester interchange catalyst. However, the ester interchange catalyst does not have to be deactivated prior to adding the antimony containing catalyst if the ester interchange catalyst does not unduly impair the color of the resulting polyester polymer melt phase product. In the case of direct esterification, a partial amount of phosphorus containing compound may be added early in the melt phase manufacturing process, such as at the initiation of polycondensation, and a final amount added late in the course of polycondensation (e.g., the phosphorus containing compound may be added after the desired It.V. is obtained.) To maximize polycondensation and/or production rates, the majority, or the bulk, or the whole of the phosphorus containing compound may be added late to the melt phase manufacturing process.

Specific examples of phosphorus containing compounds include acidic phosphorus compounds such as phosphoric acid, phosphorous acid, polyphosphoric acid, carboxyphosphonic acids, phosphonic acid derivatives, and each of their acidic salts and acidic esters and derivatives, including acidic phosphate esters such as phosphate mono- and di-esters and non acidic phosphate esters (e.g. phosphate tri-esters) such as trimethyl phosphate, triethyl phosphate, tributyl phosphate, tributoxyethyl phosphate, tris(2-ethylhexyl)phosphate, oligomeric phosphate tri-esters, trioctyl phosphate, triphenyl phosphate, tritolyl phosphate, (tris)ethylene glycol phosphate, triethyl phosphonoacetate, dimethyl methyl phosphonate, tetraisopropyl methylenediphosphonate, mixtures of mono-, di-, and tri-esters of phosphoric acid with ethylene glycol, diethylene glycol, and 2-ethylhexanol, or mixtures of each. Other examples include distearylpentaerythritol diphosphite, mono-, di-, and trihydrogen phosphate compounds, phosphite compounds, certain inorganic phosphorus compounds such as monosodium phosphate, zinc or calcium phosphates, poly(ethylene)hydrogen phosphate, silyl phosphates; phosphorus compounds used in combinations with hydroxy- or amino-substituted carboxylic acids such as methyl salicylate, maleic acid, glycine, or dibutyl tartrate; each useful for inactivating metal catalyst residues.

The quantity of phosphorus relative to the antimony atoms used in this process is not limited, but consideration is taken for the amount of antimony metal and other metals present in the melt. The molar ratio of phosphorus to antimony is, for example at least about 1:2, or in the range of 1:2 to 1:40, or 1:5 to 1:15.

The prepolymer polycondensation stage mentioned generally employs a series of two or more vessels and is operated at a temperature from about 250° C. to about 305° C. for from about one to about four hours. During this stage, the It.V. of the monomers and oligomers is typically increased up to about 0.35 dL/g. The diol by-product is removed from the prepolymer melt using an applied vacuum ranging from about 15 torr to about 70 torr to drive the reaction to completion. In this regard, the polymer melt is typically agitated to promote the escape of the diol from the polymer melt and to assist the highly viscous polymer melt in moving through the polymerization vessels. As the polymer melt is fed into successive vessels, the molecular weight and thus the intrinsic viscosity of the polymer melt increases. The temperature of each vessel is generally increased and the pressure decreased to allow for a greater degree of polymerization in each successive vessel. However, to facilitate removal of glycols, water, alcohols, aldehydes, and other reaction products, the reactors are typically run under a vacuum or purged with an inert gas. Inert gas is any gas which does not cause unwanted reaction or product characteristics at reaction conditions. Suitable gases include, but are not limited to, carbon dioxide, argon, helium, and nitrogen.

Once an It.V. of typically no greater than about 0.35 dL/g, or no greater than 0.40 dL/g, or no greater than 0.45 dL/g, is obtained, the prepolymer is fed from the prepolymer zone to a finishing zone where the second half of polycondensation is continued in one or more finishing vessels ramped up to higher temperatures than present in the prepolymerization zone, perhaps to a value within a range of from 280° C. to 305° C., until the It.V. of the melt is increased from the It.V. of the melt in the prepolymerization zone (typically 0.30 dL/g but usually not more than 0.35 dL/g) to an It.V., for example, in the range of from about 0.50 dL/g to about 0.70 dL/g. The final vessel, generally known in the industry as the “high polymerizer,” “finisher,” or “polycondenser,” is operated at a pressure lower than used in the prepolymerization zone, typically within a range of between about 0.8 torr and about 4.0 torr, or from about 0.5 torr to 4.0 torr. Although the finishing zone typically involves the same basic chemistry as the prepolymer zone, the fact that the size of the molecules, and thus the viscosity, differs, means that the reaction conditions also differ. However, like the prepolymer reactor, each of the finishing vessel(s) is connected to a flash vessel and each is typically agitated to facilitate the removal of ethylene glycol.

The residence time in the polycondensation vessels and the feed rate of the diol and the acid into the esterification zone in a continuous process is determined in part based on the target molecular weight of the PET polymer. Because the molecular weight may be readily determined based on the intrinsic viscosity of the polymer melt, the intrinsic viscosity of the polymer melt is generally used to determine polymerization conditions, such as temperature, pressure, the feed rate of the reactants, and the residence time within the polycondensation vessels.

Once the desired It.V. is obtained in the finisher, the melt may be fed to a pelletization zone where it is filtered and extruded into the desired form. The polymer melt may be filtered to remove particulates over a designated size, followed by extrusion in the melt phase to form polymer sheets, filaments, or pellets. Although this zone is termed a “pelletization zone”, it is understood that this zone is not limited to solidifying the melt into the shape of pellets, but includes solidification into any desired shape. Preferably, the polymer melt is extruded immediately after polycondensation. After extrusion, the polymers are solidified. The solidified condensation polymers are cut into any desired shape, including pellets.

The method for solidifying the PET polymer from the melt phase process is not limited. For example, molten PET polymer from the melt phase may be directed through a die, or merely cut, or both directed through a die followed by cutting the molten polymer. A gear pump may be used as the motive force to drive the molten PET polymer through the die. Instead of using a gear pump, the molten PET polymer may be fed into a single or twin screw extruder and extruded through a die, optionally at a temperature of 190° C. or more at the extruder nozzle. Once through the die, the PET polymer may be drawn into strands, contacted with a cool fluid, and cut into pellets, or the PET polymer may be pelletized at the die head, optionally underwater. The PET polymer melt is optionally filtered to remove particulates over a designated size before being cut. Any conventional hot pelletization or dicing method and apparatus may be used, including but not limited to dicing, strand pelletizing and strand (forced conveyance) pelletizing, pastillators, water ring pelletizers, hot face pelletizers, underwater pelletizers, and centrifuged pelletizers.

The method and apparatus used to crystallize the PET polymer is not limited, and includes thermal crystallization in a gas or liquid. The crystallization may occur in a mechanically agitated vessel; a fluidized bed; a bed agitated by fluid movement; an un-agitated vessel or pipe; crystallized in a liquid medium above the glass transition temperature (T_{g}) of the PET polymer, typically at 140° C. to 190° C.; or any other means known in the art. Also, the polymer may be strain crystallized. The polymer may also be fed to a crystallizer at a polymer temperature below its T_{g} (from the glass), or it may be fed to a crystallizer at a polymer temperature above its T_{g}. For example, molten polymer from the melt phase polymerization reactor may be fed through a die plate and cut underwater, and then immediately fed to an underwater thermal crystallization reactor where the polymer is crystallized underwater. Alternatively, the molten polymer may be cut, allowed to cool to below its T_{g}, and then fed to an underwater thermal crystallization apparatus or any other suitable crystallization apparatus. Or, the molten polymer may be cut in any conventional manner, allowed to cool to below its T_{g}, optionally stored, and then crystallized. Optionally, the crystallized PET polymer may be solid-stated according to known methods.

The pellets formed from the PET polymer may be subjected to a solid-stating zone wherein the solids are first crystallized followed by solid-state polymerization (SSP) to further increase the It.V. of the PET polymer pellets from the It.V. exiting the melt phase to the desired It.V. useful for the intended end use. Typically, the It.V. of solid stated PET polymer pellets ranges from 0.70 dL/g to 1.15 dL/g. In a typical SSP process, the crystallized pellets are subjected to a countercurrent flow of nitrogen gas heated to 180° C. to 220° C., over a period of time as needed to increase the It.V. to the desired target.

The polymer blends according to the invention may be prepared, for example, by adding the one or more olefinic oxygen-scavenging polymers, the one or more amide oxygen-scavengers, and the one or more oxidation catalyst to the one or more PET homopolymers or copolymers during polycondensation. Likewise, the oxygen-scavenging polymers and oxidation catalyst may be incorporated into the inventive polymer blends by melt-blending with the one or more PET homopolymers or copolymers, for example by heating the components to obtain melt homogenization in an extruder.

The one or more olefinic oxygen-scavenging polymers may be provided to the inventive polymer blends either neat or as a copolycondensate comprising one or more functionalized polybutadiene homopolymers or copolymers (referred to herein as “functionalized polybutadienes”), such as those described in U.S. Pat. No.6,083,585 and U.S. application Ser. No.11/364,916, filed Mar. 1, 2006 incorporated herein by reference in their entirety and further elaborated upon below.

The functionalized polybutadiene may thus form a copolycondensate with the PET polymer via transesterification, a reaction whereby the functionally-terminated polybutadiene segments may be considered to be substituted for some of the former polyester monomeric species originally present in the starting PET polymer. This copolycondensate may then be used to provide the inventive blends with a suitable amount of the functionalized polybutadiene. The one or more copolycondensates may comprise predominantly PET homopolymer or copolymer segments and olefinic oxygen-scavenging segments of, for example, functionalized polybutadiene in an amount, for example, from about 0.5 wt % to about 25 wt %, or from 0.5 wt % to 12 wt %, or from 2 wt % to 8 wt %, or from 2 wt % to 6 wt %, in each case based on the total weight of the copolycondensate. The olefinic oxygen-scavenging polymers may be provided to the polymer blends of the invention in amounts, for example, from about 0.025 wt % to about 0.5 wt % oxygen-scavenging polymer, or from 0.025 wt % to 0.2 wt % oxygen-scavenging polymer, or from 0.025 wt % to 0.1 wt oxygen-scavenging polymer, in each case based on the total weight of the polymer blends of the invention.

In another aspect, the one or more amide oxygen-scavenging polymers may be provided to the inventive polymer blends either neat or as a concentrate of the amide oxygen-scavenging polymer in a PET polymer and let down, for example, into an extruder or injection molding machine at a desired rate to yield a blend containing the desired amount of amide oxygen-scavenging polymer in the polymer blend of the invention. The concentrate would thus contain a concentration of amide oxygen-scavenging polymer which is higher than that desired in the polymer blend, which may be in the form of a container. Thus, the amide oxygen-scavenging polymer of the polymer blends of the invention may be provided as a concentrate, in which the amide oxygen-scavenging polymer is present in an amount, for example, of at least 10.0 wt %, or at least 15.0 wt. %, or at least 20 wt. %, and up to 40 wt. %, or up to about 50 wt %, in each case based on the total weight of the concentrate. A remainder of the concentrate may comprise, for example, a PET polymer or another thermoplastic polymer compatible with the amide oxygen-scavenging polymer and the PET homopolymer or copolymer of the inventive blends. The amide oxygen-scavenging polymers may be provided to the polymer blends of the invention in amounts, for example, from about 0.2 to about 10 wt %, or from 0.5 wt % to 5 wt. %, or from 0.5 wt % to 3.5 wt %, or from 0.5 wt % to 3 wt %, or from 0.5 wt % to 2 wt %, or from 1 wt % to 2 wt % oxygen-scavenging polymer, in each case based on the total weight of the polymer blends of the invention.

In another aspect, the olefinic oxygen-scavenging polymer and the amide oxygen-scavenging polymer may be added to the PET polymer particles or melt as a neat stream of olefinic oxygen-scavenging polymer and amide oxygen-scavenging polymer, or in a suitable carrier. Suitable liquid carriers include those which are the same as one of the reactants used to make the PET polymer in the melt phase (e.g., ethylene glycol). Alternatively, increasing the molecular weight of the polymer may not be desired, in which case a non-reactive carrier may be used.

In addition to directly forming the polymer blends of the invention with application-specific loadings of olefinic oxygen-scavenger polymer and amide oxygen-scavenging polymer, either of the former methods (e.g., during polycondensation or subsequent melt-blending) may be used to produce olefinic oxygen-scavenging copolycondensates or amide oxygen-scavenging concentrates that may subsequently be introduced to the PET homopolymer or copolymer, for example via the polymerization reactor, a melt-blending extruder, or secondary processing equipment (e.g., film extrusion line or bottle-preform molding machine).

Polymer blends of the invention comprising both the one or more olefinic oxygen-scavenging polymer and the one or more amide oxygen-scavenging polymer retain significant oxygen-scavenging properties of the oxygen-scavenging polymers upon blending, for example, melt-blending and extrusion, while retaining the properties of the one or more polyethylene terephthalate (PET) homopolymers or copolymers that make them suitable for use in packaging.

Generally, when prepared in advance of incorporation into the blends of the invention, it may be necessary or helpful to maintain the oxygen-scavenging polymers (e.g., the functionalized polybutadiene or the copolycondensates of the functionalized polybutadiene) and the products produced from the inventive blends, in an inert environment during storage prior to use as a packaging article. The oxygen-scavenging capacity for useful scavenging of oxygen may thus be significantly diminished if the blend is left exposed to oxygen (or air) for lengthy periods prior to starting its service life. Premature loss of oxygen-scavenging capacity may be avoided by storing the oxygen-scavenging polymers, the inventive blends, and products produced using the inventive blends in an inert environment or by addition of suitable stabilizing agents.

The one or more olefinic oxygen-scavenging polymers and one or more amide oxygen-scavenging polymers may be added, either neat or as a copolycondensate or a concentrate, respectively, at locations including, but not limited to, the commencement of the esterification, proximate the outlet of an esterification reactor (i.e., where there is greater than 50% conversion), proximate the inlet to a prepolymer reactor, proximate the outlet to a prepolymer reactor, at a point between the inlet and the outlet of a prepolymer reactor, proximate the inlet to a polycondensation reactor, or at a point between the inlet and the outlet of a polycondensation reactor, or at a point between the outlet of a polycondensation reactor and a die for forming pellets, sheets, fibers, bottle preforms, or the like.

The total amount of the olefinic oxygen-scavenging polymer and amide oxygen-scavenging polymer in the inventive blends may vary widely, and will depend in part on the degree of oxygen-scavenging capacity that is desired for the particular application. Typically, the total amount of the one or more polybutadiene homopolymers or copolymers in the inventive blends of the invention will be, for example, from about 0.025 to about 0.5 wt. %, or from 0.025 wt % to 0.2 wt %, or from 0.025 wt % to 0.1 wt %, in each case based on the total weight of the inventive blend. The total amount of the one or more polyamide homopolymers or copolymers in the inventive blends of the invention will typically be, for example, from about 0.02 to about 10 wt. %, or from 0.5 wt % to 5 wt %, or from 1 wt % to 2 wt %, in each case based on the total weight of the inventive blend.

Other components may also be added to the oxygen-scavenging polyester polymer blends of the present invention to enhance the performance properties of the polymer blends. For example, crystallization aids, impact modifiers, surface lubricants, denesting agents, compounds, antioxidants, ultraviolet light absorbing agents, catalyst deactivators, colorants, nucleating agents, acetaldehyde reducing compounds, other reheat rate enhancing aids, sticky bottle additives such as talc, and fillers and the like can be included. The oxygen-scavenging polymer blends may also contain small amounts of branching agents such as trifunctional or tetrafunctional comonomers such as trimellitic anhydride, trimethylol propane, pyromellitic dianhydride, pentaerythritol, and other polyester forming polyacids or diols generally known in the art. All of these additives and many others and their use are well known in the art and do not require extensive discussion. Any of these compounds can be used in the present composition.

Articles may be formed from the inventive blends by any conventional techniques known to those of skill. For example, the inventive blends may be fed to a machine for melt extruding and injection molding the melt into shapes such as preforms suitable for stretch-blow molding into beverage or food containers, or a machine for injection molding, or a machine for merely extruding into other forms such as sheet. Suitable processes for forming the articles are known and include extrusion, extrusion blow molding, melt casting, injection molding, a melt-to-mold process, stretch-blow molding (SBM), thermoforming, and the like.

Examples of the kinds of shaped articles that may be formed include sheet; film; packaging and containers such as preforms, bottles, jars, and trays; rods; tubes; lids; and filaments and fibers. Beverage bottles made from poly(ethylene terephthalate) suitable for holding water or carbonated beverages, and heat-set beverage bottles suitable for holding beverages which are hot filled into the bottles are examples of the types of bottles which may be made from the inventive polymer blends. Examples of trays are those which are dual ovenable and other trays thermoformed from poly(ethylene terephthalate) and thereafter crystallized (a.k.a., CPET trays).

Suitable methods for making articles comprise introducing particles of the inventive polymer blends or particles of components of the inventive blends into a melt processing zone and melting the particles to form a molten inventive blend; and forming an article comprising a sheet, strand, fiber, or a molded part from the molten inventive blend.

The form of the inventive polymer blends is not limited and can include a composition in the melt phase, an amorphous pellet, a semi-crystalline particle, a composition of matter in a melt processing zone, a bottle, or other articles.

This invention can be further illustrated by the additional examples of embodiments thereof, although it will be understood that these examples are included merely for purposes of illustration and are not intended to limit the scope of the invention.

### EXAMPLES

The intrinsic viscosity (It.V.) values described throughout this description are 20 set forth in dL/g unit as calculated from the inherent viscosity (Ih.V.) measured at 25° C. in 60/40 wt/wt phenol/tetrachloroethane. The inherent viscosity is calculated from the measured solution viscosity. The following equations describe these solution viscosity measurements, and subsequent calculations to Ih.V. and from Ih.V. to It.V:

ηᵢₙₕ=[ln(tₛ/tₒ)]/C
where ηᵢₙₕ=Inherent viscosity at 25° C. at a polymer concentration of 0.50 g/100 mL of 60% phenol and 40% 1,1,2,2-tetrachloroethane
   ln=Natural logarithm
   tₛ=Sample flow time through a capillary tube
   tₒ=Solvent-blank flow time through a capillary tube
   C=Concentration of polymer in grams per 100 mL of solvent (0.50%)

The intrinsic viscosity is the limiting value at infinite dilution of the specific viscosity of a polymer. It is defined by the following equation:

ηᵢₙₜ=lim_{C→0}(ηₛₚ/C)=lim_{C→0} ln(ηᵣ/C)
where ηᵢₙₜ=Intrinsic viscosity
   ηᵣ=Relative viscosity=ts/to
   ηₛₚ=Specific viscosity=ηᵣ31 1

Instrument calibration involves replicate testing of a standard reference material and then applying appropriate mathematical equations to produce the “accepted” I.V. values.

$$Calibration Factor = \frac{Accepted lh . V . of Reference Material}{Average of Triplicate Determinations}$$

Corrected IhV=Calculated IhV×Calibration Factor

The intrinsic viscosity (It.V. or ηᵢₙₜ) may be estimated using the Billmeyer equation as follows:

ηᵢₙₜ=0.5[e^{0.5×Corrected Ih.V.}−1]+(0.75×Corrected Ih.V.)

Oxygen Transmission Rate (OTR) Test Procedure

The oxygen transmission rate (OTR) test was performed using three stretch-blow-molded bottles prepared from each of Polymer Blends 1 through 12. The sets of three bottles were conditioned without capping under ambient conditions (i.e., about 22° C. and ambient humidity) for about one week after blow molding, then mounted, purged, and tested for OTR using the following procedure. Prior to measurement, the bottles were sealed by gluing it to a brass plate that is connected to a 4 way valve over the finish. This mounting technique seals the bottle, while allowing for control of test gas access. The mounting was assembled as follows. First a brass plate was prepared by drilling two ⅛ inch holes into the plate. Two lengths of ⅛ soft copper tubing (designated A and B) were passed through the holes in the plate and the gaps between the holes and the tubes were sealed either with epoxy glue or by welding. One end of each of these tubes was attached to the appropriate ports on a 4-way ball valve (such as Whitey model B-43YF2). Tubing (which will be designated C and D) and connections were also attached to the other ports of the ball valve to allow the finished assembly to be connected to an oxygen transmission rate test instrument (the OTR instrument is described below).

This mounting was then glued to the finish of the bottle to be tested so that tubes A and B extend into the interior of the bottle. The open end of one tube was positioned near the top of the package and the open end of the other was positioned near the bottom to ensure good circulation of the test gas within the bottle. Gluing of the bottle to the plate was typically performed in two steps using a quick setting epoxy to make the initial seal and temporarily hold the assembly together and then a second coating of a more rugged Metalset epoxy was applied. If desired the brass plate may be sanded before mounting to clean the surface and improve adhesion. If the 4 tubes were correctly connected to the 4-way valve, then when the valve was in the “Bypass” position, tubes A and B communicate and tubes C and D communicate, but tubes A and B did not communicate with tubes C and D. Thus the package was sealed. Similarly, when the valve was in its “Insert” position, tubes A and D communicate and tubes B and C communicates, but A and D do not communicate with tubes B and C, except through the interior of the bottle. Thus the bottle could be swept with purge or test gas.

Once the bottle was mounted on the assembly, it was swept with an oxygen-free gas, and the conditioning period begun. After several minutes of purging, the 4-way valve was moved to the Bypass position, sealing the bottle. At that point the entire bottle and mounting assembly could be disconnected from the purge gas supply without introducing oxygen into the interior of the bottle. Three bottles of each Polymer Blend-1 through -12 were mounted for testing.

When the oxygen transmission rate of the bottle was to be tested, the mounting was connected to the oxygen transmission rate instrument via tubes C and D. A custom-built instrument was used to perform the measurements on the samples discussed in the examples. Nitrogen, which was humidified using a bubbler, was supplied to the instrument and the tubing in the environmental chamber. The custom-built instrument used a Delta-F DF-310 process Oxygen analyzer as the oxygen sensor and an Aalborg Mass flow meter GFM17 to measure the ppm oxygen in and flow rate of the purge stream, from which the oxygen transmission rate through the package was calculated. The custom-built instrument had positions for up to 24 bottles to be connected to the instrument at one time. Testing of control packages on the three instruments had yielded equivalent results (within about 10% of each other). Once samples are mounted in the chamber, the 4-way valves were turned to the Insert position and the system was allowed to recover from the perturbation caused by this process.

After allowing the system to recover, the test was then begun by “inserting” the instrument sensor in-line. The test sequences were controlled by specially written LabView™ software interfaces for the instrument, by means of which the instruments automatically advanced through the test cells using a preset interval that allowed the instrument to stabilize after each cell change as the test gas from the bottle mounted on the cell was routed through the sensor. The oxygen transmission rate into the carrier gas was calculated from the measured ppm oxygen in the gas and the measured flow rate of the carrier gas. Typically, the instrument was allowed to index through each of the cells 3 or more times and the average of the last 3 measurements was used. Once these readings were obtained, the 4-way valves were moved to their Bypass positions and this process was repeated, providing a measure of the leak rate for the cell and assembly. This value was subtracted from the value obtained for the package, cell, and assembly to yield the value for the package and was reported as the oxygen transmission rate (OTR) of the bottle (in cc(STP) or μl(STP) of oxygen/day). At this point, the test was terminated and the bottles were removed from the instrument (with the 4-way valves still in the Bypass position).

Between tests, bottles were stored at ambient (RH, lighting, barometric pressure) conditions in a lab (22° C. plus or minus 4° C.) with the interior isolated from air. After a period of time, the bottles were purged with nitrogen to remove oxygen from inside the bottle and reconnected to the oxygen permeation test instrument, and a new set of transmission measurements were collected.

In this manner, it was possible to monitor the OTR behavior of the bottles over several weeks or months.

Haze Test Procedure

Haze measurements were performed on sections cut from the bottle sidewall. Three bottles were tested per Polymer Blend and the average results are reported in Table 1. Haze was measured using a BYK-Gardner Haze-Guard Plus according to ASTM D1003, Method A. Bottle sections are placed concave-in against the haze port and held taut to flatten the sample.

Twelve polymer blends (Comparative Polymer Blends 1-8 and Polymer Blends 9-12) were prepared as described below. Comparative Polymer Blends 1-8 and Polymer Blends 9-12 were prepared using copolyesters PET-1.

PET-1 was a PET copolymer containing residues of terephthalic acid, ethylene glycol, and isophthalic acid, with isophthalic acid residues representing about 2.5 mole % of the dicarboxylic acid residues. The polymer contained about 250 ppm antimony and 25 ppm phosphorus, provided as a catalyst system. PET-1 was prepared by melt polymerizing the dicarboxylic acids and diol residues in the presence of the antimony and phosphorus catalysts to an intrinsic viscosity of about 0.66 dL/g, after which the molten PET was then solidified, pelletized, and solid-state polymerized to an intrinsic viscosity of 0.84 dL/g. PET-1, as well as PET-2 through -8, also contained low levels (less than 5 mol %) of DEG residues, present as a natural byproduct of the melt polymerization process, or intentionally added as a modifier, for example to control the amount of DEG present in the final polymer.

The olefinic oxygen-scavenging polymer was supplied by BP Amoco as Amosorb 4020. The oxygen-scavenging polymer was a copolycondensate and contained hydroxyl functionalized polybutadiene oligomeric moieties (oligomeric polybutadiene moieties have a molecular weight of about 1000 to 3000 and incorporated at about 10 wt % based on weight of copolycondensate) condensed with PET oligomeric moieties (e.g., oligomers derived from commercial grade PET polymer having a 0.71 I.V. prior to reactive extrusion with the hydroxyl functionalized polybutadiene) and can be prepared as described in U.S. Pat. No. 6,083,588. In addition, the Amosorb 4020 contained about 1500 ppm cobalt metal.

The amide oxygen-scavenging polymer was a poly(m-xylylene adipamide) commercially available as MXD-6™, grade 6007 from Mitsubishi Gas.

The cobalt concentrate used was a solid concentrate prepared by melt-blending 2 wt percent cobalt neodeconate (sold as “22.5% TEN-CEM cobalt” by OMG Americas, Westlake, Ohio) with 98 wt percent polyethylene terephthalate polymer (sold as “PJ003” by Eastman Chemical Company). X-ray analysis confirmed that the cobalt concentrate contained about 4400 ppm cobalt metal.

Comparative Polymer Blend 1

Comparative Polymer Blend 1 was prepared by separately grinding 98.5 wt % PET-1 (985 g) and 1.5 wt % Amosorb™ 4020 (15 g) to pass through a 3 mm screen. PET-1 was dried in a desiccant dryer at 150° C. for 15 hours and the Amosorb™ 4020 was ground the day prior to blending and was stored in a freezer overnight after grinding. The above materials were combined as set forth in Table 1, dry-mixed, and introduced into the feed hopper of a BOY 22D molding machine (Boy Machines Inc.; Exton, Pa.). 25.7 gram preforms were molded from the blend of ground materials using the BOY 22D injection molding machine equipped with a single cavity mold. Processing conditions are given in Table 2.

Preforms molded from Comparative Polymer Blend 1 were biaxially stretch-blow molded into 500 ml round bottom bottles two days later using a custom-built reheat stretch-blow-molding machine. Bottle blowing conditions were adjusted to produce bottles exhibiting good clarity (i.e., absent haze and pearl due to preform stretch temperatures being too high or low, respectively) with similar material distribution as measured by sidewall thickness. Metal analyses of Comparative Polymer Blend 1 is reported in Table 3 and the average intrinsic viscosity, haze value, induction period in days required for oxygen-scavenging to commence, and days required for the oxygen-scavenging to expire (i.e., the OTR reach 5 μL/day) is reported in Table 4.

Comparative Polymer Blends 2-4

Comparative Polymer Blends 2-4 and corresponding samples for evaluating OTR were prepared as described for Comparative Polymer Blend 1 above using weight percents of each ingredient as set forth in Table 1. Metal analyses of the Comparative Polymer Blends 2-4 are reported in Table 3 and the average intrinsic viscosity, haze value, induction period in days required for oxygen-scavenging to commence, and days required for the oxygen-scavenging to expire (i.e., the days required for the OTR to increase above 5 μL/day) are reported in Table 4 for the respective samples.

Comparative Polymer Blend 5

Comparative Polymer Blend 5 was prepared by separately grinding 97.3 wt % PET-1 (973.1 g), 1.5 wt % MXD6 (15 g), and 1.2 wt % cobalt concentrate (11.9 g) to pass through a 3 mm screen. The ground PET-1 and cobalt concentrate were dried in a desiccant dryer at 150° C. for 15 hours; ground MXD6 was dried in a vacuum oven at 70 C with a slow purge of nitrogen for 3 days. The above materials were combined, dry-mixed, and introduced into the feed hopper of a BOY 22D molding machine (Boy Machines Inc.; Exton, Pa.). 25.7 gram preforms were molded from the blend of ground materials using the BOY 22D injection molding machine equipped with a single cavity mold. Processing conditions are given in Table 2. Metal analyses of Comparative Polymer Blend-5 is reported in Table 3 and the average intrinsic viscosity, haze value, induction period in days required for oxygen-scavenging to commence, and days required for the oxygen-scavenging to expire (i.e., the days required for the OTR to increase above 5 μL/day) is reported in Table 4.

Comparative Polymer Blends 6-8

Comparative Polymer Blends 6-8 and corresponding samples for evaluating OTR were prepared as described for Comparative Polymer Blend-5 above using weight percents of each ingredient as set forth in Table 1. Metal analyses of Comparative Polymer Blends 6-8 are reported in Table 3 and the average intrinsic viscosity, haze value, induction period in days required for oxygen-scavenging to commence, and days required for the oxygen-scavenging to expire (i.e., the days required for the OTR to increase above 5 μL/day) are reported in Table 4 for the respective samples.

Polymer Blends 9

Polymer Blend 9 was prepared by separately grinding 96.3 wt % PET-1 (963.1 g), 1 wt % Amosorb™ 4020 (10 g), 1.5 wt % MXD6 (15 g), and 1.2 wt % cobalt concentrate (11.9 g) to pass through a 3 mm screen. The ground PET-1 and cobalt concentrate were dried in a desiccant dryer at 150° C. for 15 hours; the Amosorb™ 4020 was ground the day prior to blending and was stored in a freezer overnight after grinding, and the ground MXD6 was dried in a vacuum oven at 70 C with a slow purge of nitrogen for 3 days. The above materials were combined, dry-mixed, and introduced into the feed hopper of a BOY 22D molding machine (Boy Machines Inc.; Exton, Pa.). 25.7 gram preforms were molded from the blend of ground materials using the BOY 22D injection molding machine equipped with a single cavity mold. Processing conditions are given in Table 2. Metal analyses of Polymer Blend 9 is reported in Table 3 and the average intrinsic viscosity, haze value, induction period in days required for oxygen-scavenging to commence, and days required for the oxygen-scavenging to expire (i.e., the days required for OTR to increase above 5 μL/day) is reported in Table 4.

Polymer Blends 10-12

Polymer Blends 10-12 and corresponding samples for evaluating OTR were prepared as described for Polymer Blend 9 above using weight percents of each ingredient as set forth in Table 1. Metal analyses of Polymer Blends 10-12 are reported in Table 3 and the average intrinsic viscosity, haze value, induction period in days required for oxygen-scavenging to commence, and days required for the oxygen-scavenging to expire (i.e., the days required for OTR to increase above 5 μL/day) are reported in Table 4 for the respective samples.

TABLE 1
Composition for Polymer Blends 1-12

| Polymer | | | | |
|---|---|---|---|---|
| Blend | Amosorb [g] | MXD6 [g] | Co Conc [g] | PET [g] |
| 1 | 15 | 0 | 0.0 | 985.0 |
| 2 | 20 | 0 | 0.0 | 980.0 |
| 3 | 25 | 0 | 0.0 | 975.0 |
| 4 | 30 | 0 | 0.0 | 970.0 |
| 5 | 0 | 15 | 11.4 | 973.6 |
| 6 | 0 | 20 | 11.4 | 968.6 |
| 7 | 0 | 25 | 11.4 | 963.6 |
| 8 | 0 | 30 | 11.4 | 958.6 |
| 9 | 10 | 15 | 11.4 | 963.6 |
| 10 | 10 | 10 | 11.4 | 968.6 |
| 11 | 5 | 15 | 11.4 | 968.6 |
| 12 | 5 | 10 | 11.4 | 973.6 |

TABLE 2
Boy 22D Setup for Molding Preforms

| Machine Parameter | Setting |
|---|---|
| Zone 1-3 Temperature (° C.) | 275-280 |
| Screw Speed (RPM) | 100 |
| Injection Pressure (PSIG) | 800 |
| Inject and Hold Time (sec) | 12 |
| Cooling Time (sec) | 13 |
| Total Cycle Time (sec) | 33 |

TABLE 3
Metals Analyses and Intrinsic Viscosity (It. V.).

| | X-RAY Data (ppm) | | | | | | |
|---|---|---|---|---|---|---|---|
| Polymer Blend | Co | Mn | Ti | Sb | P | Zn | Fe |
| Comparative-1 | 27.6 | 0.6 | 0.00 | 255.7 | 16.6 | 0.0 | 3.7 |
| Comparative-2 | 33.4 | 0.0 | 0.11 | 256.1 | 15.5 | 0.0 | 3.7 |
| Comparative-3 | 39.9 | 0.7 | 0.14 | 260.0 | 17.6 | 0.0 | 2.8 |
| Comparative-4 | 49.7 | 0.2 | 0.10 | 257.7 | 16.4 | 0.0 | 3.3 |
| Comparative-5 | 52.7 | 0.6 | 0.00 | 256.1 | 20.3 | 0.4 | 3.8 |
| Comparative-6 | 43.5 | 0.7 | 0.00 | 250.5 | 19.4 | 0.1 | 6.1 |
| Comparative-7 | 48.9 | 0.0 | 0.00 | 249.3 | 20.8 | 0.1 | 1.4 |
| Comparative-8 | 49.1 | 0.0 | 0.00 | 246.7 | 22.0 | 0.4 | 0.7 |
| -9 | 65.2 | 0.1 | 0.00 | 248.3 | 20.1 | 0.0 | 0.6 |
| -10 | 62.6 | 0.0 | 0.00 | 254.2 | 18.9 | 0.0 | 4.2 |
| -11 | 52.9 | 0.6 | 0.02 | 256.1 | 20.8 | 0.0 | 2.5 |
| -12 | 57.4 | 0.3 | 0.00 | 254.7 | 19.6 | 0.7 | 2.9 |

TABLE 4
Intrinsic Viscosity, Haze, Induction Period, Days for
OTR to increase above 5 μL/day

| | | | Average | Average |
|---|---|---|---|---|
| | | | Induction | Days to |
| | | | Period | OTR |
| Polymer Blend | It. V. | Haze | [Days] | >5 μL/day |
| Comparative-1 | 0.766 | 3.77 | — | 42 |
| Comparative-2 | 0.744 | 4.21 | — | 55 |
| Comparative-3 | 0.750 | 4.79 | — | 87 |
| Comparative-4 | 0.747 | 5.49 | — | 120 |
| Comparative-5 | 0.757 | 4.29 | 87 | >200 |
| Comparative-6 | 0.718 | 5.51 | 37 | >200 |
| Comparative-7 | 0.744 | 6.14 | 21 | >200 |
| Comparative-8 | 0.720 | 7.99 | 18 | >200 |
| -9 | 0.736 | 6.27 | — | >200 |
| -10 | 0.730 | 4.61 | — | 175 |
| -11 | 0.736 | 4.58 | 24 | >200 |
| -12 | 0.742 | 3.83 | 37 | 140 |

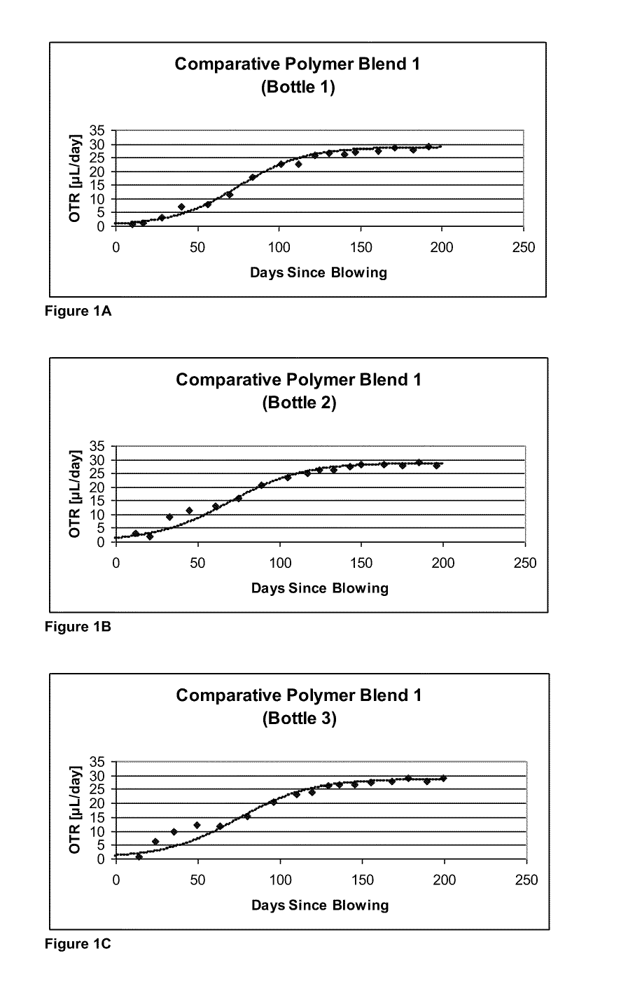

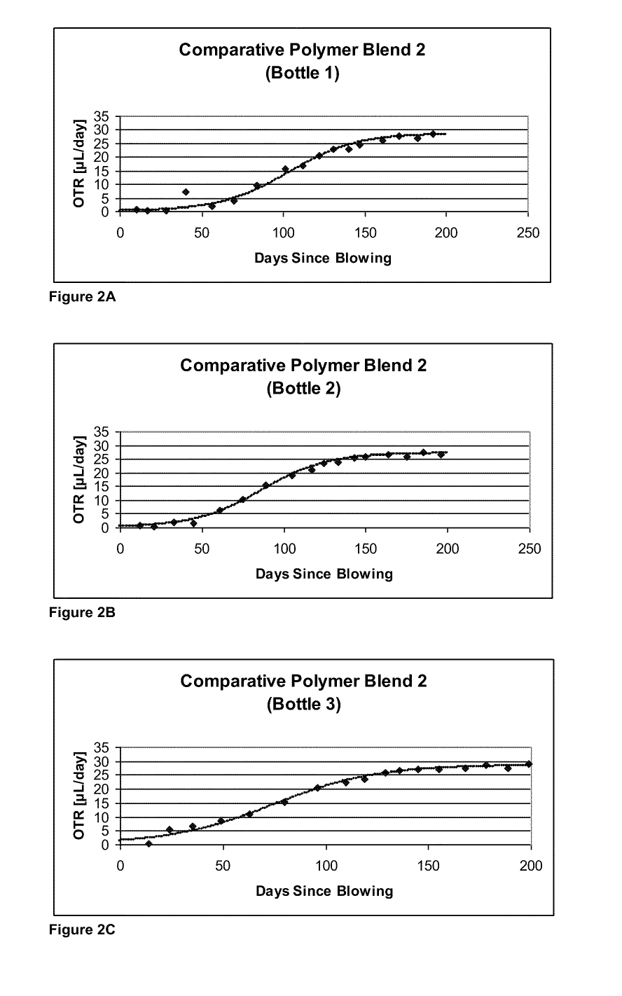

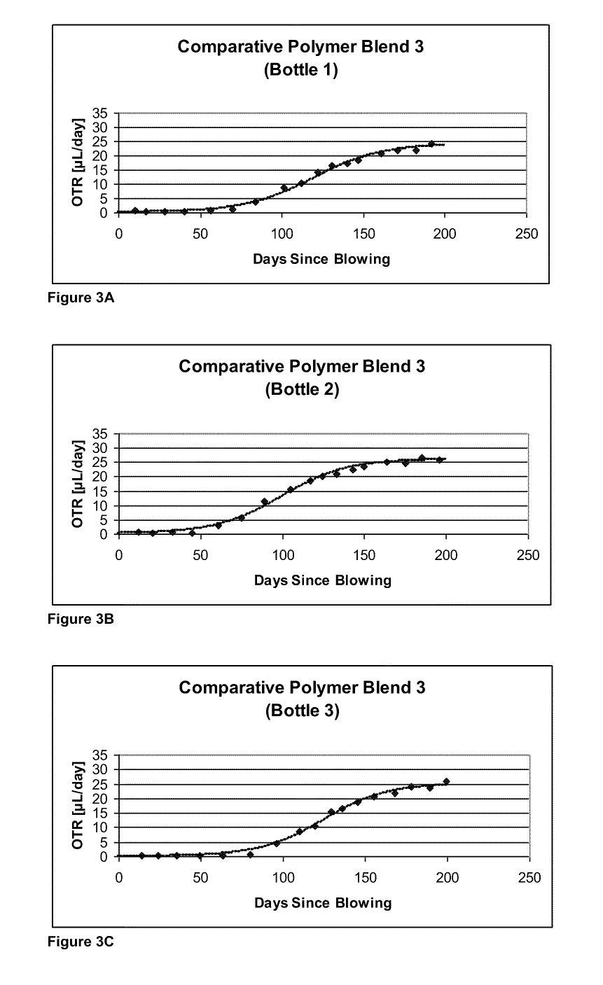

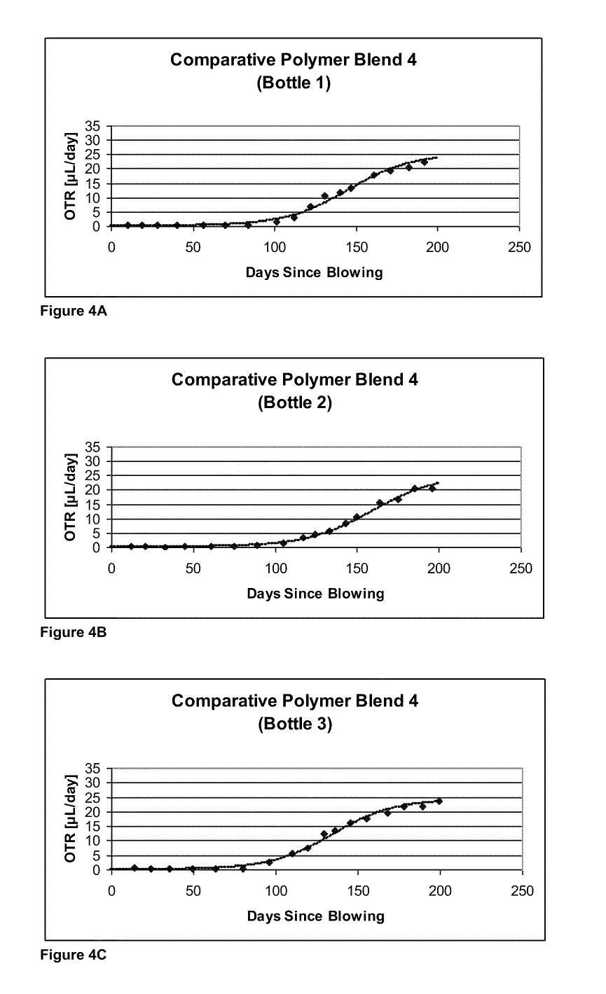

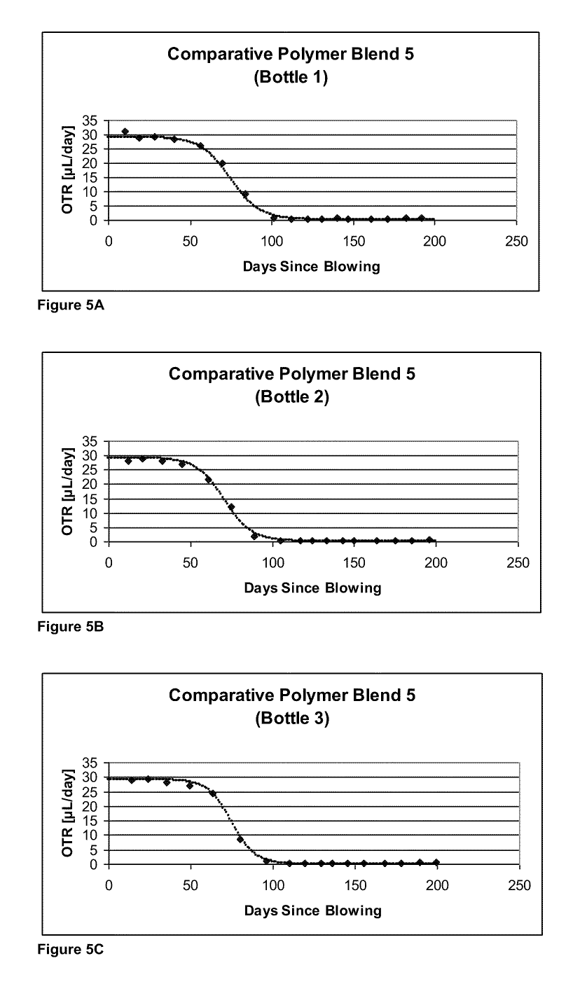

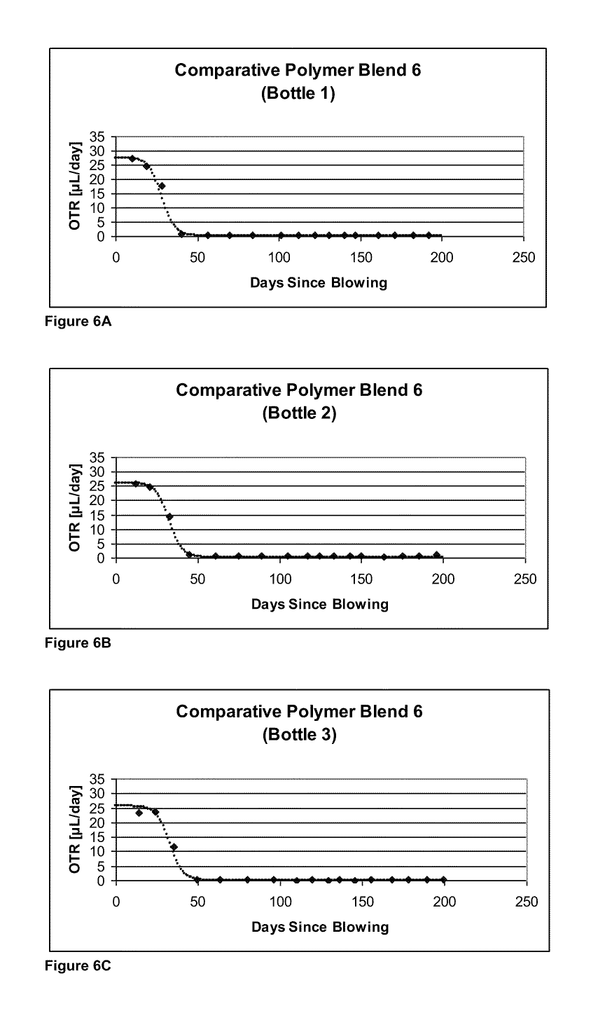

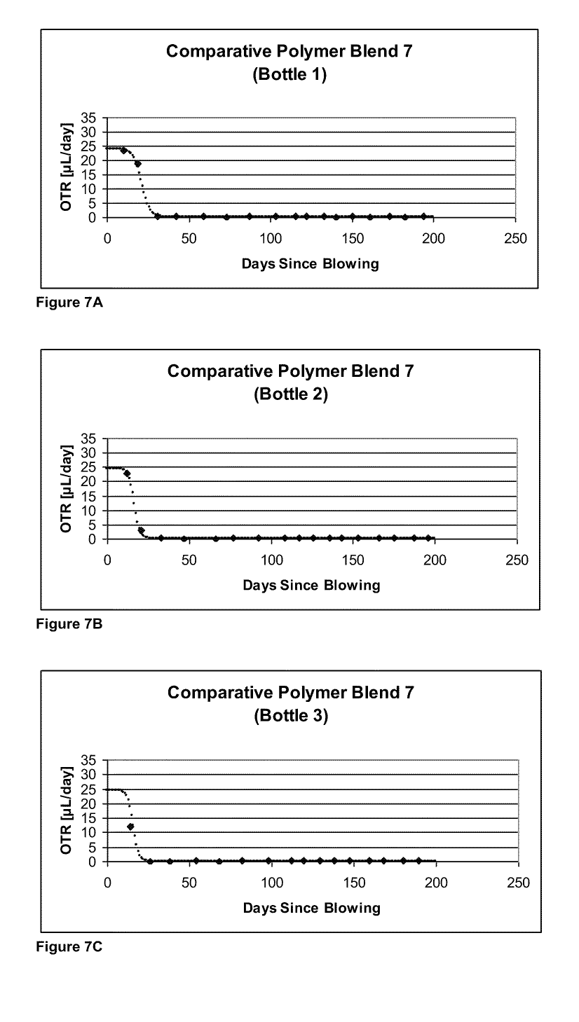

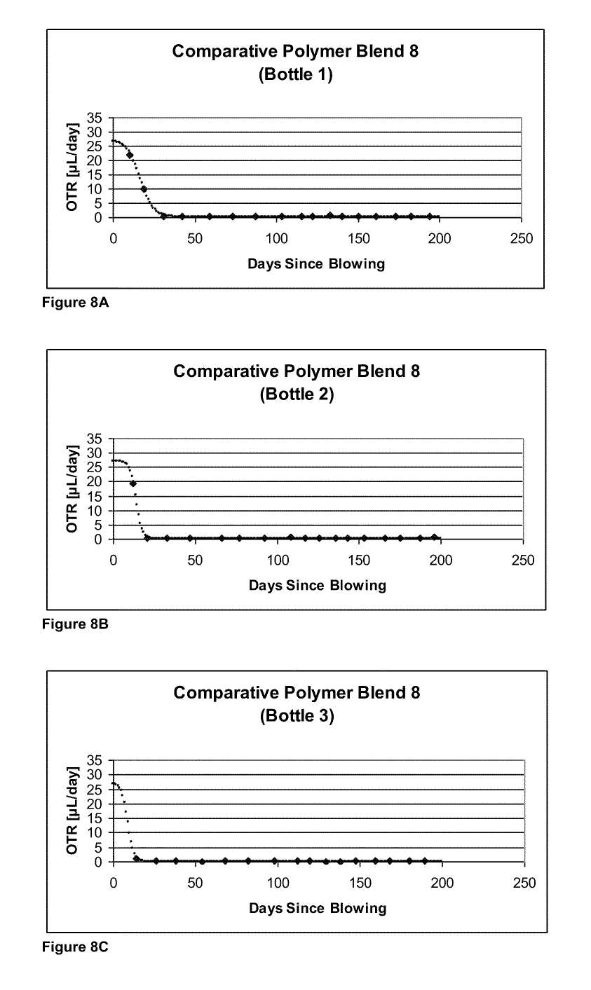

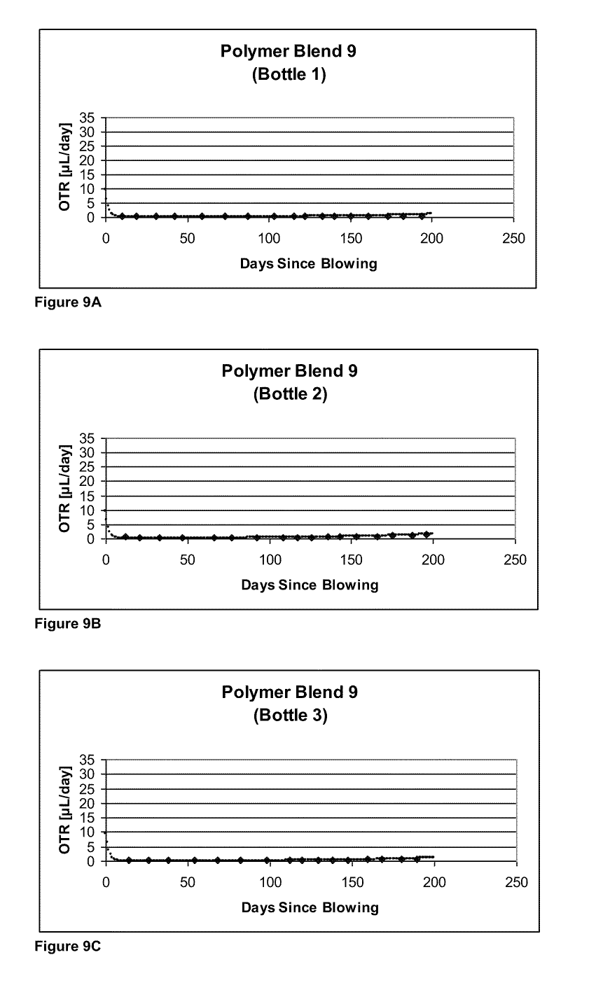

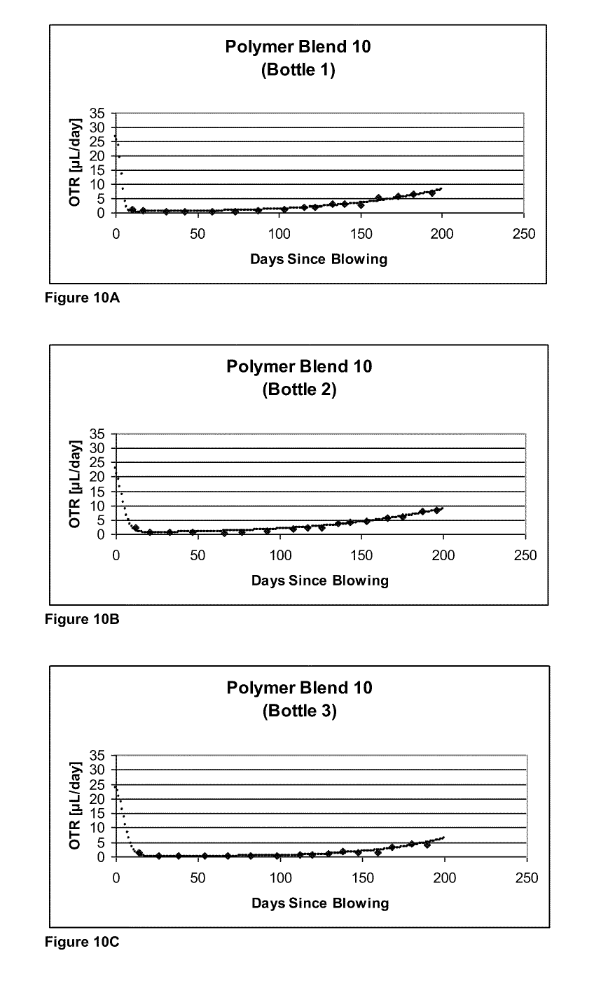

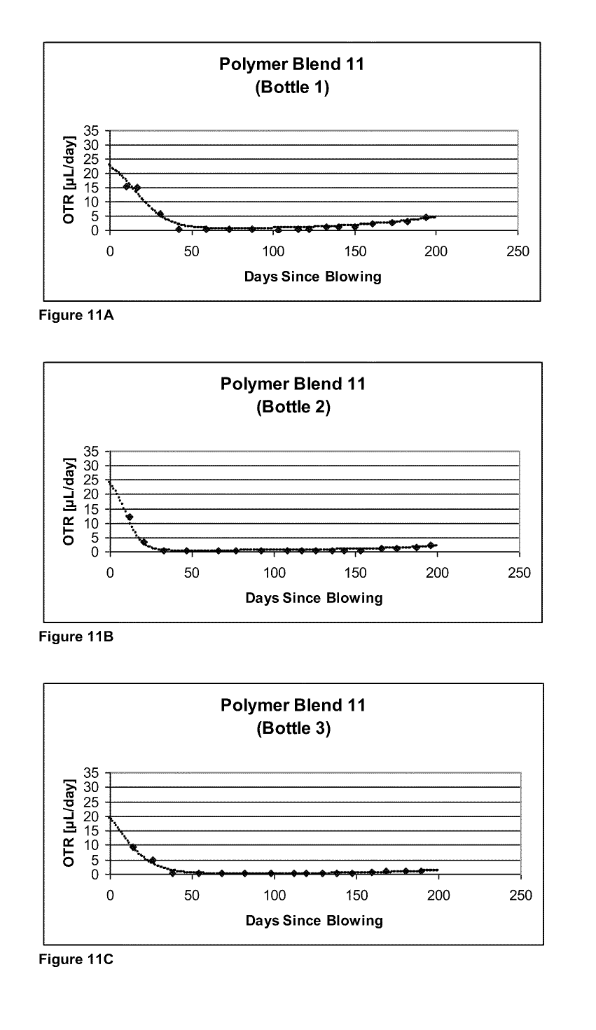

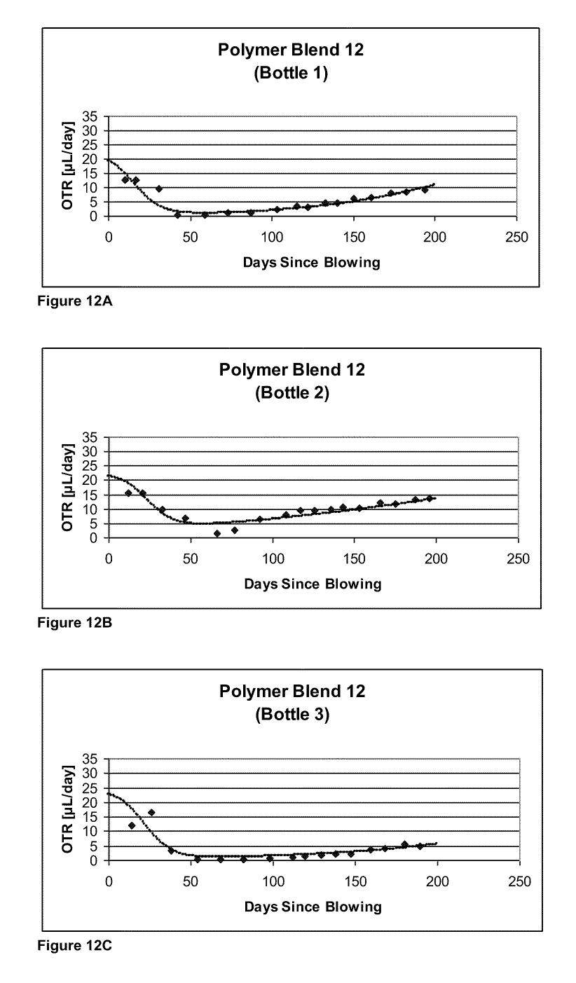

The bottles from all polymer blends were mounted for oxygen transmission rate (OTR) testing one week after blowing and tested periodically using a custom-built instrument. Results are shown in FIGS. 1A-12C.

Three stretch-blown bottles prepared using each of Polymer Blends 1-12 were tested for OTR periodically for approximately 200-days following blow molding (Tables 5-16). The OTR results for each set of three bottles are plotted in FIGS. 1A-12C, respectively, and each set of data corresponding to a single bottle has a non-linear curve superimposed over the OTR data.

The mathematical model used to generate the non-linear fits for the Polymer Blends having either the olefinic oxygen scavenging polymer or the amide oxygen-scavenging polymer (i.e., Comparative Polymer Blends 1-8) is:

$$O T R = Theta 1 + \frac{Theta 2 - Theta 1}{( 1 + exp ( Theta 3 \times ( Days - Theta 4 ) ) )} \qquad Eqn . 1$$

where
Days is “Days Since Blowing”
Theta 1—Equilibrium Point (i.e., Y-value at infinite “Days”)
Theta 2—Starting Point (y-intercept)
Theta 3—Slope
Theta 4—Inflection Point (i.e., X-value corresponding to “Days”)

and the corresponding coefficients of Eqn. 1 relating the y-coordinate (i.e., the OTR) to the x-coordinate (i.e., Days-since-blowing) for the non-linear curves corresponding to Polymer Blends 1-8 are reported in Table 17. For example, the model for Comparative Polymer Blend-1 predicts bottles 1 through 3 scavenge oxygen and are able to maintain an OTR (i.e., a y-coordinate) less than 5 μl/day for 45 days, 36 days, and 41 days, respectively (see column labeled “Days to 5 μL/day in Table 17).

The mathematical model used to generate the non-linear fits for the Polymer Blends having both the olefinic oxygen scavenging polymer and the amide oxygen scavenging polymer (i.e., Polymer Blends 9-12) is:

$$O T R = Theta 1 + \frac{Theta 2 - Theta 1}{( 1 + exp ( Theta 3 \times ( Days - Theta 4 ) ) )} + Theta 5 + \frac{Theta 6 - Theta 5}{( 1 + exp ( Theta 7 \times ( Days - Theta 8 ) ) )} \qquad Eqn . 2$$

where
Days is “Days Since Blowing”

Contribution of OTR by olefinic oxygen-scavenging polymer:
Theta 1—Equilibrium Point (i.e., Y-value at infinite “Days”)
Theta 2—Starting Point (y-intercept)
Theta 3—Slope
Theta 4—Inflection Point (i.e., X-value corresponding to “Days”)

Contribution of OTR by amide oxygen-scavenging polymer:
Theta 5—Equilibrium Point (i.e., Y-value at infinite “Days”)
Theta 6—Starting Point (y-intercept)
Theta 7—Slope
Theta 8—Inflection Point (i.e., X-value corresponding to “Days”)

and the corresponding coefficients of Eqn. 2 relating the y-coordinate (i.e., the OTR) to the x-coordinate (i.e., Days-since-blowing) for the non-linear curves corresponding to Polymer Blends 8-12 are reported in Table 17. For example, the experimental data and corresponding model for Polymer Blend 9 predict bottles 1 through 3 did not exhibit a measurable induction period and were able to scavenge oxygen so as to maintain an OTR (i.e., a y-coordinate) less than 5 μl/day for more than 200 days (see column labeled “Days to 5 μl/day in Table 17). Furthermore, Polymer Blend 9 exhibited a haze measurement equivalent to or better than the best performing Comparative Blend (i.e., Comparative Blends 8).

Comparative Polymer Blends 1-4 comprise the olefinic oxygen-scavenging polymers are exemplary of a polymer blends that do not exhibit an induction period, however their oxygen scavenging is limited to less than 120 days even at maximum olefinic oxygen-scavenging polymer loadings (i.e., they exhibit an OTR greater than 5 μl/day in less than approximately 120 days). Conversely, Comparative Polymer Blends 5-8 comprise amide oxygen-scavenging polymers and exhibit an induction period before an OTR less than 5 μl/day is achieved. However, after the induction period, polymer blends containing the amide oxygen-scavenging polymer are able to maintain an OTR less than 5 μl/day for more than 200 days.

The OTR results clearly show the inventive blends comprising both an olefinic oxygen-scavenging polymer and an amide oxygen-scavenging polymer (e.g., Polymer Blend 9) exhibit minimal induction periods (i.e., exhibits an OTR of less than 5 uL/day at first test on day 12), maintain an oxygen transmission rate less than 5 uL/day for more than 200 days, and exhibit a lower haze relative to the Comparative Blends with comparable oxygen scavenging performance.

TABLE 5
Oxygen Transmission
Rate (OTR) for Polymer Blend 1.
Comparative Polymer Blend 1

| Days | | | |
|---|---|---|---|
| since | OTR [μL/day] | | |
| blowing | Bottle 1 | Bottle 2 | Bottle 3 |
| 10 | 0.87 | | |
| 12 | | 3.33 | |
| 14 | | | 0.62 |
| 17 | 1.28 | | |
| 21 | | 2.06 | |
| 24 | | | 6.32 |
| 28 | 3.35 | | |
| 33 | | 9.05 | |
| 35 | | | 9.73 |
| 40 | 7.2 | | |
| 45 | | 11.57 | |
| 49 | | | 12.04 |
| 56 | 8.04 | | |
| 61 | | 13.3 | |
| 63 | | | 11.96 |
| 70 | 11.71 | | |
| 75 | | 16.07 | |
| 80 | | | 15.52 |
| 84 | 18.06 | | |
| 89 | | 20.79 | |
| 96 | | | 20.39 |
| 101 | 22.85 | | |
| 105 | | 23.3 | |
| 110 | | | 23.02 |
| 112 | 22.85 | | |
| 117 | | 24.95 | |
| 119 | | | 24.1 |
| 122 | 25.66 | | |
| 124 | | 26.43 | |
| 129 | | | 26.39 |
| 131 | 26.67 | | |
| 133 | | 26.11 | |
| 136 | | | 26.87 |
| 140 | 26.4 | | |
| 143 | | 27.52 | |
| 145 | | | 26.89 |
| 147 | 26.98 | | |
| 150 | | 28.25 | |
| 155 | | | 27.45 |
| 161 | 27.56 | | |
| 164 | | 28.41 | |
| 168 | | | 27.91 |
| 171 | 28.8 | | |
| 175 | | 27.79 | |
| 178 | | | 29.1 |
| 182 | 27.92 | | |
| 185 | | 28.85 | |
| 189 | | | 27.74 |
| 192 | 29.07 | | |
| 196 | | 27.87 | |
| 199 | | | 29.01 |

TABLE 6
Oxygen Transmission
Rate (OTR) for Polymer Blend 2.
Comparative Polymer Blend 2

| Days | | | |
|---|---|---|---|
| since | OTR [μL/day] | | |
| blowing | Bottle 1 | Bottle 2 | Bottle 3 |
| 10 | 0.8 | | |
| 12 | | 0.8 | |
| 14 | | | 0.37 |
| 17 | 0.5 | | |
| 21 | | 0.36 | |
| 24 | | | 5.31 |
| 28 | 0.4 | | |
| 33 | | 1.96 | |
| 35 | | | 6.73 |
| 40 | 7.11 | | |
| 45 | | 1.68 | |
| 49 | | | 8.61 |
| 56 | 1.88 | | |
| 61 | | 6.36 | |
| 63 | | | 11.12 |
| 70 | 3.84 | | |
| 75 | | 10.34 | |
| 80 | | | 15.35 |
| 84 | 9.5 | | |
| 89 | | 15.55 | |
| 96 | | | 20.28 |
| 101 | 15.51 | | |
| 105 | | 18.96 | |
| 110 | | | 22.58 |
| 112 | 16.93 | | |
| 117 | | 21.08 | |
| 119 | | | 23.61 |
| 122 | 20.42 | | |
| 124 | | 23.35 | |
| 129 | | | 26.03 |
| 131 | 22.98 | | |
| 133 | | 24.01 | |
| 136 | | | 26.93 |
| 140 | 23.07 | | |
| 143 | | 25.41 | |
| 145 | | | 27.02 |
| 147 | 24.45 | | |
| 150 | | 25.79 | |
| 155 | | | 27.21 |
| 161 | 26.2 | | |
| 164 | | 26.83 | |
| 168 | | | 27.54 |
| 171 | 27.65 | | |
| 175 | | 26.02 | |
| 178 | | | 28.75 |
| 182 | 26.99 | | |
| 185 | | 27.53 | |
| 189 | | | 27.51 |
| 192 | 28.64 | | |
| 196 | | 26.45 | |
| 199 | | | 28.91 |

TABLE 7
Oxygen Transmission
Rate (OTR) for Polymer Blend 3.
Comparative Polymer Blend 3

| Days | | | |
|---|---|---|---|
| since | OTR [μL/day] | | |
| blowing | Bottle 1 | Bottle 2 | Bottle 3 |
| 10 | 0.58 | | |
| 12 | | 0.62 | |
| 14 | | | 0.41 |
| 17 | 0.31 | | |
| 21 | | 0.3 | |
| 24 | | | 0.29 |
| 28 | 0.35 | | |
| 33 | | 0.63 | |
| 35 | | | 0.28 |
| 40 | 0.36 | | |
| 45 | | 0.51 | |
| 49 | | | 0.29 |
| 56 | 0.66 | | |
| 61 | | 3.18 | |
| 63 | | | 0.48 |
| 70 | 1.17 | | |
| 75 | | 5.77 | |
| 80 | | | 0.76 |
| 84 | 3.71 | | |
| 89 | | 11.4 | |
| 96 | | | 4.59 |
| 101 | 8.82 | | |
| 105 | | 15.47 | |
| 110 | | | 8.84 |
| 112 | 10.38 | | |
| 117 | | 18.51 | |
| 119 | | | 10.72 |
| 122 | 14.42 | | |
| 124 | | 20.12 | |
| 129 | | | 15.44 |
| 131 | 16.7 | | |
| 133 | | 20.93 | |
| 136 | | | 16.62 |
| 140 | 17.31 | | |
| 143 | | 22.44 | |
| 145 | | | 18.81 |
| 147 | 18.49 | | |
| 150 | | 23.62 | |
| 155 | | | 20.7 |
| 161 | 20.59 | | |
| 164 | | 25 | |
| 168 | | | 21.65 |
| 171 | 22.06 | | |
| 175 | | 24.69 | |
| 178 | | | 24.23 |
| 182 | 21.95 | | |
| 185 | | 26.59 | |
| 189 | | | 23.75 |
| 192 | 24.04 | | |
| 196 | | 25.71 | |
| 199 | | | 25.8 |

TABLE 8
Oxygen Transmission
Rate (OTR) for Polymer Blend 4.
Comparative Polymer Blend 4

| Days | | | |
|---|---|---|---|
| since | OTR [μL/day] | | |
| blowing | Bottle 1 | Bottle 2 | Bottle 3 |
| 10 | 0.57 | | |
| 12 | | 0.39 | |
| 14 | | | 0.59 |
| 19 | 0.44 | | |
| 21 | | 0.24 | |
| 24 | | | 0.48 |
| 28 | 0.28 | | |
| 33 | | 0.19 | |
| 35 | | | 0.41 |
| 40 | 0.38 | | |
| 45 | | 0.24 | |
| 49 | | | 0.51 |
| 56 | 0.24 | | |
| 61 | | 0.25 | |
| 63 | | | 0.45 |
| 70 | 0.27 | | |
| 75 | | 0.36 | |
| 80 | | | 0.49 |
| 84 | 0.47 | | |
| 89 | | 0.68 | |
| 96 | | | 2.8 |
| 101 | 1.53 | | |
| 105 | | 1.35 | |
| 110 | | | 5.72 |
| 112 | 3.14 | | |
| 117 | | 3.54 | |
| 119 | | | 7.66 |
| 122 | 6.76 | | |
| 124 | | 4.59 | |
| 129 | | | 12.36 |
| 131 | 10.58 | | |
| 133 | | 5.71 | |
| 136 | | | 13.59 |
| 140 | 11.82 | | |
| 143 | | 8.37 | |
| 145 | | | 16.27 |
| 147 | 13.32 | | |
| 150 | | 10.69 | |
| 155 | | | 17.78 |
| 161 | 17.75 | | |
| 164 | | 15.44 | |
| 168 | | | 19.44 |
| 171 | 19.49 | | |
| 175 | | 16.84 | |
| 178 | | | 21.89 |
| 182 | 20.43 | | |
| 185 | | 20.62 | |
| 189 | | | 21.73 |
| 192 | 22.42 | | |
| 196 | | 20.43 | |
| 199 | | | 23.77 |

TABLE 9
Oxygen Transmission
Rate (OTR) for Polymer Blend 5.
Comparative Polymer Blend 5

| Days | | | |
|---|---|---|---|
| since | OTR [μL/day] | | |
| blowing | Bottle 1 | Bottle 2 | Bottle 3 |
| 10 | 31.34 | | |
| 12 | | 28.24 | |
| 14 | | | 29.09 |
| 19 | 29.01 | | |
| 21 | | 28.95 | |
| 24 | | | 29.54 |
| 28 | 29.12 | | |
| 33 | | 28.05 | |
| 35 | | | 28.37 |
| 40 | 28.31 | | |
| 45 | | 27.04 | |
| 49 | | | 27.16 |
| 56 | 26.12 | | |
| 61 | | 21.68 | |
| 63 | | | 24.58 |
| 70 | 19.81 | | |
| 75 | | 12.3 | |
| 80 | | | 8.65 |
| 84 | 9.1 | | |
| 89 | | 2 | |
| 96 | | | 1.31 |
| 101 | 0.78 | | |
| 105 | | 0.4 | |
| 110 | | | 0.31 |
| 112 | 0.49 | | |
| 117 | | 0.51 | |
| 119 | | | 0.34 |
| 122 | 0.41 | | |
| 124 | | 0.51 | |
| 129 | | | 0.49 |
| 131 | 0.47 | | |
| 133 | | 0.36 | |
| 136 | | | 0.54 |
| 140 | 0.6 | | |
| 143 | | 0.34 | |
| 145 | | | 0.43 |
| 147 | 0.47 | | |
| 150 | | 0.39 | |
| 155 | | | 0.51 |
| 161 | 0.44 | | |
| 164 | | 0.34 | |
| 168 | | | 0.42 |
| 171 | 0.46 | | |
| 175 | | 0.31 | |
| 178 | | | 0.42 |
| 182 | 0.66 | | |
| 185 | | 0.56 | |
| 189 | | | 0.68 |
| 192 | 0.76 | | |
| 196 | | 0.82 | |
| 199 | | | 0.89 |

TABLE 10
Oxygen Transmission
Rate (OTR) for Polymer Blend 6.
Comparative Polymer Blend 6

| Days | | | |
|---|---|---|---|
| since | OTR [μL/day] | | |
| blowing | Bottle 1 | Bottle 2 | Bottle 3 |
| 10 | 27.45 | | |
| 12 | | 25.94 | |
| 14 | | | 23.42 |
| 19 | 24.74 | | |
| 21 | | 24.55 | |
| 24 | | | 23.73 |
| 28 | 17.79 | | |
| 33 | | 14.28 | |
| 35 | | | 11.6 |
| 40 | 0.79 | | |
| 45 | | 1.32 | |
| 49 | | | 0.4 |
| 56 | 0.5 | | |
| 61 | | 0.83 | |
| 63 | | | 0.3 |
| 70 | 0.5 | | |
| 75 | | 0.8 | |
| 80 | | | 0.19 |
| 84 | 0.43 | | |
| 89 | | 0.7 | |
| 96 | | | 0.33 |
| 101 | 0.28 | | |
| 105 | | 0.79 | |
| 110 | | | 0.09 |
| 112 | 0.35 | | |
| 117 | | 0.63 | |
| 119 | | | 0.21 |
| 122 | 0.31 | | |
| 124 | | 0.63 | |
| 129 | | | 0.16 |
| 131 | 0.37 | | |
| 133 | | 0.79 | |
| 136 | | | 0.25 |
| 140 | 0.33 | | |
| 143 | | 0.64 | |
| 145 | | | 0.18 |
| 147 | 0.37 | | |
| 150 | | 0.72 | |
| 155 | | | 0.33 |
| 161 | 0.23 | | |
| 164 | | 0.47 | |
| 168 | | | 0.51 |
| 171 | 0.3 | | |
| 175 | | 0.85 | |
| 178 | | | 0.19 |
| 182 | 0.34 | | |
| 185 | | 0.94 | |
| 189 | | | 0.28 |
| 192 | 0.56 | | |
| 196 | | 0.97 | |
| 199 | | | 0.31 |

TABLE 11
Oxygen Transmission
Rate (OTR) for Polymer Blend 7.
Comparative Polymer Blend 7

| Days | | | |
|---|---|---|---|
| since | OTR [μL/day] | | |
| blowing | Bottle 1 | Bottle 2 | Bottle 3 |
| 10 | 23.51 | | |
| 12 | | 22.68 | |
| 14 | | | 11.93 |
| 19 | 18.79 | | |
| 21 | | 3.02 | |
| 26 | | | 0.11 |
| 31 | 0.52 | | |
| 33 | | 0.25 | |
| 38 | | | 0 |
| 42 | 0.28 | | |
| 47 | | 0.17 | |
| 54 | | | 0.2 |
| 59 | 0.26 | | |
| 66 | | 0.1 | |
| 68 | | | 0.11 |
| 73 | 0.19 | | |
| 77 | | 0.42 | |
| 82 | | | 0.38 |
| 87 | 0.37 | | |
| 92 | | 0.26 | |
| 98 | | | 0.5 |
| 103 | 0.33 | | |
| 108 | | 0.48 | |
| 112 | | | 0.36 |
| 115 | 0.36 | | |
| 117 | | 0.2 | |
| 119 | | | 0.29 |
| 122 | 0.39 | | |
| 126 | | 0.26 | |
| 129 | | | 0.44 |
| 133 | 0.21 | | |
| 136 | | 0.31 | |
| 138 | | | 0.23 |
| 140 | 0.16 | | |
| 143 | | 0.31 | |
| 147 | | | 0.24 |
| 150 | 0.28 | | |
| 153 | | 0.33 | |
| 159 | | | 0.35 |
| 161 | 0.14 | | |
| 166 | | 0.26 | |
| 168 | | | 0.28 |
| 173 | 0.29 | | |
| 175 | | 0.25 | |
| 180 | | | 0.45 |
| 182 | 0.17 | | |
| 187 | | 0.38 | |
| 189 | | | 0.32 |
| 194 | 0.33 | | |
| 196 | | 0.26 | |
| 203 | | | 0.38 |

TABLE 12
Oxygen Transmission
Rate (OTR) for Polymer Blend 8.
Comparative Polymer Blend 8

| Days | | | |
|---|---|---|---|
| since | OTR [μL/day] | | |
| blowing | Bottle 1 | Bottle 2 | Bottle 3 |
| 10 | 21.92 | | |
| 12 | | 19.3 | |
| 14 | | | 1.24 |
| 19 | 9.93 | | |
| 21 | | 0.49 | |
| 26 | | | 0.29 |
| 31 | 0.37 | | |
| 33 | | 0.24 | |
| 38 | | | 0.3 |
| 42 | 0.37 | | |
| 47 | | 0.32 | |
| 54 | | | 0.14 |
| 59 | 0.34 | | |
| 66 | | 0.34 | |
| 68 | | | 0.21 |
| 73 | 0.32 | | |
| 77 | | 0.48 | |
| 82 | | | 0.24 |
| 87 | 0.36 | | |
| 92 | | 0.5 | |
| 98 | | | 0.25 |
| 103 | 0.33 | | |
| 108 | | 0.58 | |
| 112 | | | 0.23 |
| 115 | 0.36 | | |
| 117 | | 0.41 | |
| 119 | | | 0.27 |
| 122 | 0.43 | | |
| 126 | | 0.4 | |
| 129 | | | 0.17 |
| 133 | 0.59 | | |
| 136 | | 0.33 | |
| 138 | | | 0.18 |
| 140 | 0.36 | | |
| 143 | | 0.35 | |
| 147 | | | 0.25 |
| 150 | 0.31 | | |
| 153 | | 0.26 | |
| 159 | | | 0.4 |
| 161 | 0.27 | | |
| 166 | | 0.3 | |
| 168 | | | 0.27 |
| 173 | 0.27 | | |
| 175 | | 0.26 | |
| 180 | | | 0.28 |
| 182 | 0.32 | | |
| 187 | | 0.3 | |
| 189 | | | 0.32 |
| 194 | 0.38 | | |
| 196 | | 0.69 | |
| 203 | | | 0.27 |

TABLE 13
Oxygen Transmission
Rate (OTR) for Polymer Blend 9.
Comparative Polymer Blend 9

| Days | | | |
|---|---|---|---|
| since | OTR [μL/day] | | |
| blowing | Bottle 1 | Bottle 2 | Bottle 3 |
| 10 | 0.57 | | |
| 12 | | 0.67 | |
| 14 | | | 0.53 |
| 19 | 0.43 | | |
| 21 | | 0.34 | |
| 26 | | | 0.29 |
| 31 | 0.3 | | |
| 33 | | 0.23 | |
| 38 | | | 0.48 |
| 42 | 0.32 | | |
| 47 | | 0.3 | |
| 54 | | | 0.19 |
| 59 | 0.25 | | |
| 66 | | 0.3 | |
| 68 | | | 0.37 |
| 73 | 0.38 | | |
| 77 | | 0.4 | |
| 82 | | | 0.26 |
| 87 | 0.51 | | |
| 92 | | 0.43 | |
| 98 | | | 0.29 |
| 103 | 0.34 | | |
| 108 | | 0.45 | |
| 112 | | | 0.45 |
| 115 | 0.29 | | |
| 117 | | 0.34 | |
| 119 | | | 0.27 |
| 122 | 0.32 | | |
| 126 | | 0.51 | |
| 129 | | | 0.35 |
| 133 | 0.36 | | |
| 136 | | 0.79 | |
| 138 | | | 0.42 |
| 140 | 0.36 | | |
| 143 | | 0.62 | |
| 147 | | | 0.46 |
| 150 | 0.32 | | |
| 153 | | 0.6 | |
| 159 | | | 0.57 |
| 161 | 0.35 | | |
| 166 | | 0.78 | |
| 168 | | | 0.71 |
| 173 | 0.36 | | |
| 175 | | 1.02 | |
| 180 | | | 0.92 |
| 182 | 0.46 | | |
| 187 | | 1.11 | |
| 189 | | | 0.92 |
| 194 | 0.56 | | |
| 196 | | 1.52 | |
| 203 | | | 1.4 |

TABLE 14
Oxygen Transmission
Rate (OTR) for Polymer Blend 10.
Comparative Polymer Blend 10

| Days | | | |
|---|---|---|---|
| since | OTR [μL/day] | | |
| blowing | Bottle 1 | Bottle 2 | Bottle 3 |
| 10 | 1.3 | | |
| 12 | | 2.11 | |
| 14 | | | 1.41 |
| 17 | 0.77 | | |
| 21 | | 0.74 | |
| 26 | | | 0.38 |
| 31 | 0.21 | | |
| 33 | | 0.61 | |
| 38 | | | 0.42 |
| 42 | 0.37 | | |
| 47 | | 0.72 | |
| 54 | | | 0.31 |
| 59 | 0.37 | | |
| 66 | | 0.52 | |
| 68 | | | 0.46 |
| 73 | 0.55 | | |
| 77 | | 0.72 | |
| 82 | | | 0.3 |
| 87 | 0.76 | | |
| 92 | | 1.14 | |
| 98 | | | 0.51 |
| 103 | 1.07 | | |
| 108 | | 1.92 | |
| 112 | | | 0.66 |
| 115 | 2.03 | | |
| 117 | | 2.27 | |
| 119 | | | 0.9 |
| 122 | 2.07 | | |
| 126 | | 2.38 | |
| 129 | | | 1.28 |
| 133 | 3.05 | | |
| 136 | | 3.65 | |
| 138 | | | 1.88 |
| 140 | 3.07 | | |
| 143 | | 4.03 | |
| 147 | | | 1.56 |
| 150 | 2.76 | | |
| 153 | | 4.56 | |
| 159 | | | 1.65 |
| 161 | 5.35 | | |
| 166 | | 5.67 | |
| 168 | | | 3.5 |
| 173 | 5.72 | | |
| 175 | | 6.2 | |
| 180 | | | 4.5 |
| 182 | 6.64 | | |
| 187 | | 7.97 | |
| 189 | | | 4.02 |
| 194 | 6.76 | | |
| 196 | | 8.36 | |
| 203 | | | 5.84 |

TABLE 15
Oxygen Transmission
Rate (OTR) for Polymer Blend 11.
Comparative Polymer Blend 11

| Days | | | |
|---|---|---|---|
| since | OTR [μL/day] | | |
| blowing | Bottle 1 | Bottle 2 | Bottle 3 |
| 10 | 15.33 | | |
| 12 | | 12.06 | |
| 14 | | | 9.33 |
| 17 | 15.11 | | |
| 21 | | 3.32 | |
| 26 | | | 4.8 |
| 31 | 5.61 | | |
| 33 | | 0.4 | |
| 38 | | | 0.42 |
| 42 | 0.44 | | |
| 47 | | 0.29 | |
| 54 | | | 0.22 |
| 59 | 0.23 | | |
| 66 | | 0.28 | |
| 68 | | | 0.56 |
| 73 | 0.22 | | |
| 77 | | 0.26 | |
| 82 | | | 0.33 |
| 87 | 0.31 | | |
| 92 | | 0.5 | |
| 98 | | | 0.24 |
| 103 | 0.03 | | |
| 108 | | 0.31 | |
| 112 | | | 0.38 |
| 115 | 0.56 | | |
| 117 | | 0.31 | |
| 119 | | | 0.42 |
| 122 | 0.54 | | |
| 126 | | 0.41 | |
| 129 | | | 0.46 |
| 133 | 0.98 | | |
| 136 | | 0.5 | |
| 138 | | | 0.54 |
| 140 | 1.02 | | |
| 143 | | 0.51 | |
| 147 | | | 0.54 |
| 150 | 1.15 | | |
| 153 | | 0.57 | |
| 159 | | | 0.68 |
| 161 | 2.13 | | |
| 166 | | 0.98 | |
| 168 | | | 1 |
| 173 | 2.78 | | |
| 175 | | 1.09 | |
| 180 | | | 1.17 |
| 182 | 3.2 | | |
| 187 | | 1.63 | |
| 189 | | | 1.27 |
| 194 | 4.43 | | |
| 196 | | 2.14 | |
| 203 | | | 1.84 |

TABLE 16
Oxygen Transmission
Rate (OTR) for Polymer Blend 12.
Comparative Polymer Blend 12

| Days | | | |
|---|---|---|---|
| since | OTR [μL/day] | | |
| blowing | Bottle 1 | Bottle 2 | Bottle 3 |
| 10 | 12.67 | | |
| 12 | | 15.59 | |
| 14 | | | 11.92 |
| 17 | 12.85 | | |
| 21 | | 15.55 | |
| 26 | | | 16.67 |
| 31 | 9.55 | | |
| 33 | | 9.77 | |
| 38 | | | 3.5 |
| 42 | 0.51 | | |
| 47 | | 6.74 | |
| 54 | | | 0.24 |
| 59 | 0.53 | | |
| 66 | | 1.39 | |
| 68 | | | 0.47 |
| 73 | 0.97 | | |
| 77 | | 2.78 | |
| 82 | | | 0.44 |
| 87 | 1.31 | | |
| 92 | | 6.42 | |
| 98 | | | 0.86 |
| 103 | 2.14 | | |
| 108 | | 7.87 | |
| 112 | | | 1.11 |
| 115 | 3.59 | | |
| 117 | | 9.34 | |
| 119 | | | 1.57 |
| 122 | 3.26 | | |
| 126 | | 9.33 | |
| 129 | | | 2.02 |
| 133 | 4.7 | | |
| 136 | | 9.97 | |
| 138 | | | 2.09 |
| 140 | 4.71 | | |
| 143 | | 10.48 | |
| 147 | | | 2.19 |
| 150 | 6.09 | | |
| 153 | | 10.38 | |
| 159 | | | 3.79 |
| 161 | 6.65 | | |
| 166 | | 12.13 | |
| 168 | | | 4.19 |
| 173 | 7.93 | | |
| 175 | | 11.82 | |
| 180 | | | 5.63 |
| 182 | 8.28 | | |
| 187 | | 13.37 | |
| 189 | | | 4.82 |
| 194 | 9.15 | | |
| 196 | | 13.52 | |
| 203 | | | 7.1 |

TABLE 17
Oxygen Transmission Rate Fit Parameters

| | | | | | | | | | | Induction | |
|---|---|---|---|---|---|---|---|---|---|---|---|
| Polymer | | | | | | | | | | Period | Days to |
| Blend | Bottle | Theta 1 | Theta 2 | Theta 3 | Theta 4 | Theta 5 | Theta 6 | Theta 7 | Theta 8 | [Days]¹ | 5 μl/day² |
| 1 | 1 | 28.5 | 0 | 0.05 | 76 | | | | | — | 45 |
| 1 | 2 | 28.5 | 0 | 0.045 | 70 | | | | | — | 36 |
| 1 | 3 | 28.5 | 0 | 0.045 | 75 | | | | | — | 41 |
| 2 | 1 | 28.5 | 0 | 0.048 | 104 | | | | | — | 72 |
| 2 | 2 | 27 | 0 | 0.05 | 87 | | | | | — | 58 |
| 2 | 3 | 28.5 | 0 | 0.04 | 75 | | | | | — | 36 |
| 3 | 1 | 24 | 0 | 0.048 | 120 | | | | | — | 92 |
| 3 | 2 | 26 | 0 | 0.05 | 100 | | | | | — | 72 |
| 3 | 3 | 25 | 0 | 0.052 | 125 | | | | | — | 98 |
| 4 | 1 | 25 | 0 | 0.052 | 146 | | | | | — | 119 |
| 4 | 2 | 25 | 0 | 0.05 | 160 | | | | | — | 110 |
| 4 | 3 | 24 | 0 | 0.054 | 135 | | | | | — | 132 |
| 5 | 1 | 0 | 29 | 0.11 | 75 | | | | | 91 | >200 |
| 5 | 2 | 0 | 29 | 0.12 | 71 | | | | | 84 | >200 |
| 5 | 3 | 0 | 29 | 0.14 | 75 | | | | | 86 | >200 |
| 6 | 1 | 0 | 27.5 | 0.25 | 28.5 | | | | | 34 | >200 |
| 6 | 2 | 0 | 26 | 0.25 | 33 | | | | | 39 | >200 |
| 6 | 3 | 0 | 25.5 | 0.25 | 33 | | | | | 39 | >200 |
| 7 | 1 | 0 | 24 | 0.4 | 21.5 | | | | | 25 | >200 |
| 7 | 2 | 0 | 24.5 | 0.6 | 17 | | | | | 20 | >200 |
| 7 | 3 | 0 | 24.5 | 0.6 | 16 | | | | | 19 | >200 |
| 8 | 1 | 0 | 27 | 0.25 | 17 | | | | | 23 | >200 |
| 8 | 2 | 0 | 27 | 0.55 | 14.5 | | | | | 18 | >200 |
| 8 | 3 | 0 | 27 | 0.55 | 9 | | | | | 12 | >200 |
| 9 | 1 | 27 | 0 | −0.6 | 2 | 0 | 27 | −0.022 | 350 | — | >200 |
| 9 | 2 | 27 | 0 | −0.6 | 2 | 0 | 27 | −0.019 | 350 | — | >200 |
| 9 | 3 | 27 | 0 | −0.6 | 2 | 0 | 27 | −0.02 | 360 | — | >200 |
| 10 | 1 | 27 | 0 | −0.9 | 4 | 0 | 27 | −0.022 | 240 | — | 173 |
| 10 | 2 | 27 | 0 | −0.4 | 4 | 0 | 27 | −0.019 | 240 | — | 162 |
| 10 | 3 | 27 | 0 | −0.4 | 5 | 0 | 27 | −0.03 | 240 | — | 191 |
| 11 | 1 | 27 | 0 | −0.1 | 16 | 0 | 27 | −0.022 | 275 | 31 | >200 |
| 11 | 2 | 27 | 0 | −0.2 | 10 | 0 | 27 | −0.019 | 340 | 18 | >200 |
| 11 | 3 | 30 | 0 | −0.1 | 6 | 0 | 27 | −0.03 | 300 | 22 | >200 |
| 12 | 1 | 22 | 0 | −0.12 | 16 | 0 | 27 | −0.022 | 220 | 27 | 153 |
| 12 | 2 | 20 | 0 | −0.12 | 24 | 0 | 30 | −0.011 | 220 | 48 | 73 |
| 12 | 3 | 24 | 0 | −0.12 | 22 | 0 | 30 | −0.015 | 300 | 35 | 193 |

¹Induction Period: Days required for OTR to decrease below 5 μl/day (i.e., days before oxygen-scavenging meets maximum requirement).
²Days to 5 μl/day: Days required for OTR to increase above 5 μl/day (i.e., days required for oxygen-scavenging to become ineffective).

We claim:

1. A polymer blend having oxygen scavenging activity, comprising:
one or more ethylenically unsaturated homopolymers or copolymers having at least one functionality capable of entering into condensation reactions;
one or more polyamide homopolymers or copolymers comprising at least about 50 mole percent residues of one or more amine monomers containing a benzylic hydrogen, based on the total amount of amine residues comprising 100 mole percent;
one or more polyethylene terephthalate homopolymers or copolymers obtained using a catalyst system comprising antimony atoms in an amount at least about 100 ppm, in each case based on the weight of the one or more polyethylene terephthalate homopolymers or copolymers; and
one or more transition metal atoms in an amount from about 10 ppm to about 1,000 ppm metal, based on the total weight of the polymer blend.

2. The polymer blend of claim 1, wherein the one or more ethylenically unsaturated homopolymers or copolymers are present in an amount from about 0.025 wt % to about 0.5 wt %, based on the total weight of the polymer blend.

3. The polymer blend of claim 1, wherein the one or more ethylenically unsaturated homopolymers or copolymers are provided with an average of at least two functionalities capable of entering into condensation reactions.

4. The polymer blend of claim 1, wherein the functionality capable of entering into condensation reactions comprises hydroxyl functionality.

5. The polymer blend of claim 1, wherein the weight average molecular weight of the one or more ethylenically unsaturated homopolymers or copolymers is from about 100 g/mole to about 10,000 g/mole.

6. The polymer blend of claim 1, wherein the one or more ethylenically unsaturated homopolymers or copolymers comprises a polybutadiene homopolymer or copolymer.

7. The polymer blend of claim 1, wherein the one or more polyamide homopolymers or copolymers are present in an amount from about 0.20 weight percent to about 10 weight percent, based on the total weight of the polymer blend.

8. The polymer blend of claim 1, wherein the one or more polyamide homopolymers or copolymers comprise at least 80 percent amide linkages, based on the total number of condensation linkages of the one or more polyamide homopolymers or copolymers comprising 100 percent.

9. The polymer blend of claim 1, wherein the one or more polyamide homopolymers or copolymers comprise at least 50 mole percent m-xylylenediamine residues, based on the total amount of amine residues comprising 100 mole percent.

10. The polymer blend of claim 1, wherein the one or more polyamide homopolymers or copolymers comprise repeating units of m-xylylene adipamide, in an amount of at least 50 mole percent, based on the total moles of acid/amine units in the one or more polyamide homopolymers or copolymers comprising 100 mole percent.

11. The polymer blend of claim 1, wherein the one or more polyamide homopolymers or copolymers comprise a m-xylylene adipamide homopolymer.

12. The polymer blend of claim 1, wherein the one or more polyamide homopolymers or copolymers have an number average molecular weight from about 200 to about 25,000.

13. The polymer blend of claim 1, wherein the one or more polyethylene terephthalate homopolymers or copolymers comprise:
a carboxylic acid component comprising at least about 80 mole % of the residues of terephthalic acid, or derivates of terephthalic acid and
a hydroxyl component comprising at least about 80 mole % of the residues of ethylene glycol,
based on 100 mole percent of carboxylic acid component residues and 100 mole percent of hydroxyl component residues in the one or more polyethylene terephthalate homopolymers or copolymers.

14. The polymer blend of claim 1, wherein the one or more polyethylene terephthalate homopolymers or copolymers have an It.V. of at least about 0.76 dL/g.

15. The polymer blend of claim 1, wherein the one or more polyethylene terephthalate homopolymers or copolymers further comprise residues of a catalyst deactivator.

16. The polymer blend of claim 15, wherein the catalyst deactivator comprises phosphorus atoms in an amount from about 20 ppm to about 40 ppm, based on the total weight of the polymer blend of the invention.

17. The polymer blend of claim 15, wherein the catalyst deactivator comprises phosphorus atoms present in an amount such that a molar ratio of phosphorus atoms to the total moles of antimony atoms is about 1:5 to about 1:15.

18. The polymer blend of claim 1, wherein the one or more transition metal atoms are provided as one or more transition metal salts.

19. The polymer blend of claim 1, wherein the one or more transition metal atoms comprise one or more of: manganese II or III, iron II or III, cobalt II or III, nickel II or III, copper I or II, rhodium II, III or IV, or ruthenium I, II or IV.

20. The polymer blend of claim 1, wherein the one or more transition metal atoms are provided as a salt of one or more of a chloride, an acetate, an acetylacetonate, a stearate, a palmitate, a 2-ethylhexanoate, a neodecanoate, an octoate or a naphthenate.

21. The polymer blend of claim 1, wherein the one or more transition metal atoms comprise cobalt in an amount from 20 ppm to 120 ppm, based on the weight of the cobalt with respect to the weight of the polymer blend.

22. The polymer blend of claim 1, wherein the one or more transition metal atoms is provided as cobalt neodecanoate so as to provide an amount of cobalt atoms from 20 ppm to 120 ppm, based on the weight of the cobalt with respect to the weight of the polymer blend.

23. The polymer blend of claim 1, wherein the blend is in the form of a bottle preform.
